(19) United States
(12) Patent Application Publication
(10) Pub. No.: US 2006/0222958 A1
(43) Pub. Date: Oct. 5, 2006

(54) BATTERY

(76) Inventors: Akira Yamaguchi, Fukushima (JP); Takashi Murakami, Fukushima (JP); Masayuki Ihara, Fukushima (JP); Kumiko Takagi, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/278,460

(22) Filed: Apr. 3, 2006

(30) Foreign Application Priority Data
Apr. 4, 2005 (JP) P2005-107783

(51) Int. Cl. H01M 10/40; H01M 4/58

(52) U.S. Cl. 429/324; 429/218.1; 429/231.8; 429/200; 429/338

(57) ABSTRACT

A battery capable of improving high temperature characteristics is provided. An electrolytic solution is impregnated in a separator. The electrolytic solution contains an imide salt expressed by LiN(CₙF₂ₙ₊₁SO₂)(CₘF₂ₘ₊₁SO₂) (n and m are respectively an integer number from 1 to 4, and a different value from each other). Thereby, a coat stable even at high temperatures can be formed on the surface of a cathode or an anode, and chemical stability of the electrolytic solution at high temperatures can be improved. LiPF₆ is preferably mixed in the electrolytic solution.

### CROSS REFERENCES TO RELATED APPLICATIONS

The present invention contains subject matter related to Japanese Patent Application JP 2005-107783 filed in the Japanese Patent Office on Apr. 4, 2005, the entire contents of which being incorporated herein by reference.

### BACKGROUND OF THE INVENTION

1. Field of the Invention

The present invention relates to a battery using an electrolytic solution containing an imide salt.

2. Description of the Related Art

In recent years, many portable electronic devices such as combination cameras (videotape recorder), mobile phones, and notebook computers have been introduced, and their size and weight have been reduced. Accordingly, as a power source for the electronic devices, lightweight secondary batteries capable of providing a high energy density have been developed. As a secondary battery capable of providing a high energy density, for example, lithium secondary batteries are known.

In the lithium secondary batteries, since the anode becomes a strong reducing agent in a charged state, the electrolytic solution is easily decomposed in the anode, and thereby the discharge capacity is lowered. Therefore, traditionally, in order to improve the battery characteristics such as cycle characteristics, various compositions of the electrolytic solution have been considered. As an example, using 4-fluoro-1,3-dioxolane-2-one has been reported (for example, refer to Japanese Unexamined Patent Application Publication No. H07-240232).

### SUMMARY OF THE INVENTION

However, since heat generation from the high-performance CPU of personal computers is increased, batteries are often charged and discharged under high temperatures of about 50 deg C., leading to a disadvantage that battery characteristics are thereby lowered. Therefore, development of batteries capable of providing superior cycle characteristics under high temperature environment of about 50 deg C. in addition to in the environment of room temperatures has been desired.

In view of such a disadvantage, in the present invention, it is desirable to provide a battery capable of improving the high temperature characteristics.

According to an embodiment of the present invention, there is provided a battery including a cathode, an anode, and an electrolytic solution, in which the electrolytic solution contains an imide salt expressed by LiN(CₙF₂ₙ₊₁SO₂)(CₘF₂ₘ₊₁SO₂) (n and m are respectively an integer number from 1 to 4, and a different value from each other).

According to the battery of the embodiment of the present invention, the electrolytic solution contains LiN(CₙF₂ₙ₊₁SO₂)(CₘF₂ₘ₊₁SO₂). Thereby, high temperature stability of a coat formed on the surface of the cathode or the anode can be improved. Therefore, chemical stability of the electrolytic solution at high temperatures can be improved, and high temperature characteristics can be improved.

In particular, when the imide salt content in the electrolytic solution is in the range from 0.01 mol/l to 1.5 mol/l, or the electrolytic solution further contains lithium hexafluorophosphate, higher characteristics can be obtained

Other and further objects, features and advantages of the invention will appear more fully from the following description.

### BRIEF DESCRIPTION OF THE DRAWINGS

FIG. 1 is a cross section showing a structure of a secondary battery according to a first embodiment of the present invention;

FIG. 2 is a cross section showing an enlarged part of a spirally wound electrode body in the secondary battery shown in FIG. 1;

FIG. 3 is an exploded perspective view showing a structure of a secondary battery according to a third embodiment of the present invention;

FIG. 4 is a cross section showing a structure taken along line I-I of a spirally wound electrode body shown in FIG. 3; and

FIG. 5 is an example of peaks obtained by X-ray photoelectron spectroscopy according to a CoSnC-containing material formed in examples.

### DETAILED DESCRIPTION OF THE PREFERRED EMBODIMENTS

Embodiments of the present invention will be hereinafter described in detail with reference to the drawings.

### First Embodiment

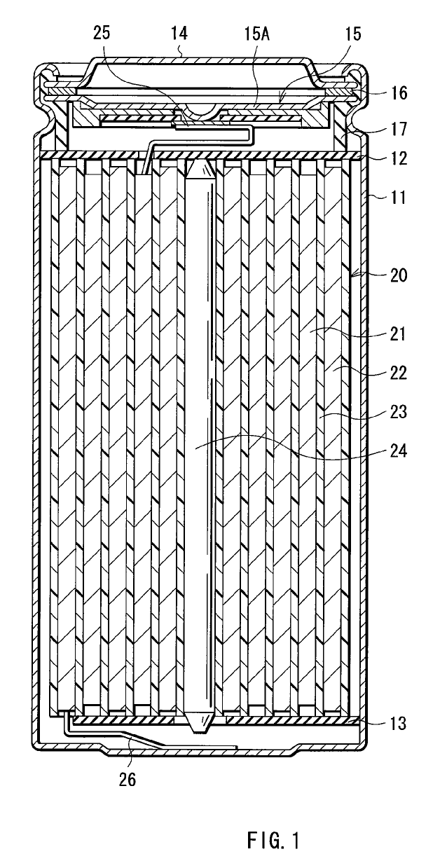

FIG. 1 shows a cross sectional structure of a secondary battery according to a first embodiment of the present invention. The secondary battery is a so-called lithium ion secondary battery in which the anode capacity is expressed by the capacity component due to insertion and extraction of lithium (Li) as an electrode reactant. The secondary battery is a so-called cylinder type battery, and has a spirally wound electrode body 20 in which a pair of a strip-shaped cathode 21 and a strip-shaped anode 22 is wound with a separator 23 in between inside a battery can 11 in the shape of approximately hollow cylinder. The battery can 11 is made of, for example, iron (Fe) plated by nickel (Ni). One end of the battery can 11 is closed, and the other end of the battery can 11 is opened. An electrolytic solution is injected into the battery can 11, and impregnated in the separator 23. A pair of insulating plates 12 and 13 is respectively arranged perpendicular to the spirally wound periphery face, so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is thereby hermetically sealed. The battery cover 14 is made of, for example, a material similar to that of the battery can 11. The safety valve mechanism 15 is electrically connected to the battery cover 14 through the PTC device 16. When the internal pressure of the battery becomes a certain level or more by internal short circuit, external heating or the like, a disk plate 15A flips to cut the electrical connection between the battery cover 14 and the spirally wound electrode body 20. When temperatures rise, the PTC device 16 limits a current by increasing the resistance value to prevent abnormal heat generation by a large current. The gasket 17 is made of, for example, an insulating material and its surface is coated with asphalt.

For example, a center pin 24 is inserted in the center of the spirally wound electrode body 20. A cathode lead 25 made of aluminum (Al) or the like is connected to the cathode 21 of the spirally wound electrode body 20. An anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

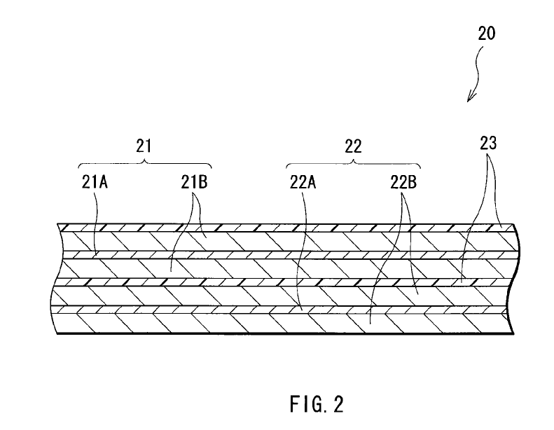

FIG. 2 shows an enlarged part of the spirally wound electrode body 20 shown in FIG. 1. The cathode 21 has a structure in which, for example, a cathode active material layer 21B is provided on the both faces of a cathode current collector 21A having a pair of opposed faces. The cathode current collector 21A is made of, for example, a metal foil such as an aluminum foil.

The cathode active material layer 21B contains, for example, as a cathode active material, one or more cathode materials capable of inserting and extracting lithium. If necessary, the cathode active material layer 21B may contain an electrical conductor such as a carbon material and a binder such as polyvinylidene fluoride. As a cathode material capable of inserting and extracting lithium, for example, a chalcogenide not containing lithium such as titanium sulfide (TiS₂), molybdenum sulfide (MoS₂), niobium selenide (NbSe₂), and vanadium oxide (V₂O₅); or a lithium-containing compound which contains lithium can be cited.

Specially, the lithium-containing compound is preferable since some lithium-containing compounds can provide a high voltage and a high energy density. As such a lithium-containing compound, for example, a complex oxide containing lithium and transition metal elements, or a phosphate compound containing lithium and transition metal elements can be cited. In particular, a compound containing at least one of cobalt (Co), nickel, and manganese (Mn) is preferable, since such a compound can provide a higher voltage. The chemical formula thereof is expressed by, for example, LiₓMIO₂ or Li_{y}MIIPO₄. In the formula, MI and MII represent one or more transition metal elements. Values of x and y vary according to charge and discharge states of the battery, and are generally in the range of 0.05≦x≦1.10 and 0.05≦y≦1.10.

As a specific example of the complex oxide containing lithium and transition metal elements, a lithium-cobalt complex oxide (LiₓCoO₂), a lithium-nickel complex oxide (LiₓNiO₂), a lithium-nickel-cobalt complex oxide (LiₓNi_{1-z}Co_{z}O₂ (z<1)), a lithium-nickel-cobalt-manganese complex oxide (LiₓNi_{1(1-v-w)}CoᵥMn_{w}O₂ (v+w<1)), lithium-manganese complex oxide having a spinel structure (LiMn₂O₄) and the like can be cited. Specially, a complex oxide containing nickel is preferable, since a high capacity, and superior cycle characteristics can be obtained. As a specific example of the phosphate compound containing lithium and transition metal elements, for example, lithium-iron phosphate compound (LiFePO₄) or a lithium-iron-manganese phosphate compound (LiFe₁₋ᵤMnᵤPO₄ (u<1)) can be cited.

Similarly to the cathode 21, the anode 22 has a structure in which, for example, an anode active material layer 22B is provided on the both faces of an anode current collector 22A having a pair of opposed faces. The anode current collector 22A is made of a metal foil such as a copper (Cu) foil.

The anode active material layer 22B contains one or more anode materials capable of inserting and extracting lithium. If necessary, the anode active material layer 22B may contain an electrical conductor and a binder. As an anode material capable of inserting and extracting lithium, for example, a carbon material such as non-graphitizable carbon, artificial graphite, natural graphite, pyrolytic carbons, cokes, graphites, glassy carbons, an organic high molecular weight compound fired body, carbon fiber, activated carbon and carbon blacks can be cited. Of the foregoing, cokes include pitch cokes, needle cokes, petroleum cokes and the like. The organic high molecular weight compound fired body is obtained by firing and carbonizing a high molecular weight compound such as a phenol resin and a furan resin at an appropriate temperature.

As an anode material capable of inserting and extracting lithium, a material which is capable of inserting and extracting lithium and contains at least one of metal elements and metalloid elements as an element can be also cited. Such an anode material is preferably used, since a high energy density can be thereby obtained. Such an anode material may be a simple substance, an alloy, or a compound of a metal element or a metalloid element, or may have one or more phases thereof at least in part. In the present invention, alloys include an alloy containing one or more metal elements and one or more metalloid elements, in addition to an alloy including two or more metal elements. Further, an alloy may contain nonmetallic elements. The texture thereof includes a solid solution, a eutectic crystal (eutectic mixture), an intermetallic compound, and a texture coexisting two or more intermetallic compounds.

As such a metal element or such a metalloid element composing the anode material, for example, a metal element or a metalloid element capable of forming an alloy with lithium can be cited. Specifically, magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), platinum (Pt) or the like can be cited. Of the foregoing, silicon or tin is particularly preferable because silicon and tin have a high ability to insert and extract lithium, and can provide a high energy density.

As such an anode material, for example, an anode material containing tin as a first element, a second element, and a third element is preferable. As the second element, at least one from the group consisting of cobalt, iron, magnesium, titanium (Ti), vanadium (V), chromium (Cr), manganese, nickel, copper, zinc, gallium, zirconium, niobium (Nb), molybdenum (Mo), silver, indium, cerium (Ce), hafnium, tantalum (Ta), tungsten (W), bismuth, and silicon is used. As the third element, at least one from the group consisting of boron, carbon (C), aluminum, and phosphorus (P) is used. When the second element and the third element are contained, cycle characteristics can be improved.

Specially, as such an anode material, a SnCoC-containing material which contains tin, cobalt, and carbon as an element, the carbon content is from 9.9 wt % to 29.7 wt %, and the cobalt ratio to the total of tin and cobalt (Co/(Sn+Co)) is from 30 wt % to 70 wt % is preferable. In such a composition range, a high energy density can be obtained, and superior cycle characteristics can be obtained.

The SnCoC-containing material may contain other element according to needs. As other element, for example, silicon, iron, nickel, chromium, indium, niobium, germanium, titanium, molybdenum, aluminum, phosphorus, gallium, or bismuth is preferable. Two or more other elements may be contained, since thereby the capacity or the cycle characteristics can be further improved.

The SnCoC-containing material has a phase containing tin, cobalt, and carbon. Such a phase preferably has a low crystallinity structure or an amorphous structure. Further, in the SnCoC-containing material, at least part of carbon as an element is preferably bonded to a metal element or a metalloid element as other element. It is thinkable that lowering of cycle characteristics is caused by cohesion or crystallization of tin or the like. When carbon is bonded to other element, such cohesion or crystallization can be inhibited.

As a measuring method for examining bonding state of elements, for example, X-ray Photoelectron Spectroscopy (XPS) can be cited. In XPS, in the case of graphite, the peak of is orbital of carbon (C1s) is observed at 284.5 eV in the apparatus in which energy calibration is made so that the peak of 4f orbital of gold atom (Au4f) is observed at 84.0 eV. In the case of surface contamination carbon, the peak is observed at 284.8 eV. Meanwhile, in the case of higher electric charge density of carbon element, for example, when carbon is bonded to a metal element or a metalloid element, the peak of C1s is observed in the region lower than 284.5 eV. That is, when the peak of the composite wave of C1s obtained for the SnCoC-containing material is observed in the region lower than 284.5 eV, at least part of carbon contained in the SnCoC-containing material is bonded to the metal element or the metalloid element, which is other element.

In XPS measurement, for example, the peak of C1s is used for correcting the energy axis of spectrums. Since surface contamination carbon generally exists on the surface, the peak of C1s of the surface contamination carbon is set to at 284.8 eV, which is used as an energy reference. In XPS measurement, the waveform of the peak of C1s is obtained as a form including the peak of the surface contamination carbon and the peak of carbon in the SnCoC-containing material. Therefore, by analyzing the waveform by using a commercially available software or the like, the peak of the surface contamination carbon and the peak of carbon in the SnCoC-containing material are separated. In the analysis of the waveform, the position of the main peak existing on the lowest bound energy side is set to the energy reference (284.8 eV).

In this embodiment, by adjusting the amount of the cathode active material and the amount of the anode material capable of inserting and extracting lithium, the charging capacity by the anode material capable of inserting and extracting lithium is set to be larger than the charging capacity by the cathode active material so that lithium metal is not precipitated on the anode 22 when fully charged.

The separator 23 separates the cathode 21 from the anode 22, and lets through lithium ions while it prevents current short circuit due to contact of the both electrodes. The separator 23 is made of, for example, a porous film made of a synthetic resin such as polytetrafluoroethylene, polypropylene, and polyethylene, or a ceramics porous film. The separator 23 may have a structure in which two or more porous films as the foregoing porous films are layered.

The electrolytic solution impregnated in the separator 23 contains a solvent and an electrolyte salt dissolved in the solvent. As a solvent, a nonaqueous solvent such as ester carbonate can be cited. Nonaqueous solvents are categorized into, for example, high-boiling point solvents with the boiling point higher than 150 deg C. and low-boiling point solvents with the boiling point of 150 deg C. or less in the atmospheric pressure (1.01325×10⁵ Pa). A mixture of a high-boiling point solvent and a low-boiling point solvent is preferably used, since high ion conductivity can be obtained.

As a high-boiling point solvent, for example, cyclic ester carbonate such as ethylene carbonate, propylene carbonate, butylene carbonate, and 1,3-dioxole-2-one; lactone such as γ-butyrolactone and γ-valerolactone; lactam such as 2-methyl-1-pyrrolidone; cyclic carbamic ester such as 3-methyl-2-oxazolidinone; or cyclic sulfone such as tetramethylenesulfone can be cited. As a low-boiling point solvent, for example, chain ester carbonate such as diethyl carbonate, dimethyl carbonate, ethyl methyl carbonate, and methyl propyl carbonate; chain carboxylate ester such as methyl acetate, ethyl acetate, methyl propionate, ethyl propionate, methyl isobutyrate, and trimethylacetic acid methyl; ketone such as pinacolin; ether such as 1,2-dimethoxyethane, tetrahydrofuran, tetrahydropyran, 1,3-dioxolane, 1,3-dioxane, and 1,4-dioxane; chain amide such as N,N-dimethyl formamide and N,N-dimethyl acetamide; or chain carbamic acid ester such as N,N-dimethyl carbamic acid methyl, N,N-diethyl carbamic acid methyl can be cited. One of the solvents may be used singly, or two or more thereof may be used by mixing.

As a high-boiling point solvent, further, 4-fluoro-1,3-dioxolane-2-one shown in Chemical formula 1 is more preferably used. Thereby, decomposition reaction of the electrolytic solution in the anode 22 can be inhibited, and cycle characteristics can be improved.

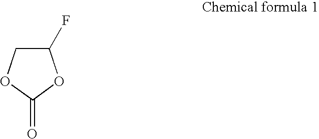

The electrolyte salt contains an imide salt expressed by LiN(CₙF₂ₙ₊₁SO₂)(CₘF₂ₘ₊₁SO₂) (n and m are respectively an integer number from 1 to 4, and a different value from each other). Thereby, a coat stable even at high temperatures can be formed on the surface of the cathode 21 or the anode 22, and decomposition reaction of the electrolytic solution at high temperatures can be inhibited. One imide salt may be used singly, or two or more thereof may be used by mixing. The content of LiN(CₙF₂ₙ₊₁SO₂)(CₘF₂ₘ₊₁SO₂) in the electrolytic solution is preferably in the range from 0.01 mol/l to 1.5 mol/l. When the content is small, effect to inhibit decomposition of the electrolytic solution is low. When the content is large, the viscosity of the electrolytic solution becomes high, and the ion conductivity is lowered.

Further, the electrolyte salt may be composed of only the imide salt, or may be composed of a mixture of the imide salt and other one or more lithium salts. As other lithium salt, lithium hexafluorophosphate (LiPF₆), lithium borate tetrafluoride (LiBF₄), lithium arsenate hexafluoride (LiAsF₆), lithium perchlorate (LiClO₄), methanesulfonic acid lithium (CH₃SO₃Li), trifluoro methane sulfonic lithium (LiCF₃SO₃), lithium chloride (LiCl), lithium bromide (LIBr), tetraphenyl borate lithium (LiB(C₆H₅)₄), lithium tris (trifluoromethanesulfonyl)methide (LiC(CF₃SO₂)₃), or lithium bis oxalate borate (LiB(C₂O₄)₂) can be cited. Specially, lithium hexafluorophosphate is preferably mixed, since high characteristics can be obtained.

The secondary battery can be manufactured, for example, as follows.

First, for example, the cathode 21 is formed by forming the cathode active material layer 21B on the cathode current collector 21A. The cathode active material layer 21B is formed, for example, as follows. Cathode active material powder, an electrical conductor, and a binder are mixed to prepare a cathode mixture, which is dispersed in a solvent such as N-methyl-2-pyrrolidone to obtain paste cathode mixture slurry. Then, the cathode current collector 21A is coated with the cathode mixture slurry, which is dried, and the resultant is compression-molded. Consequently, the cathode active material layer 21B is formed. Further, for example, in the same manner as in the cathode 21, the anode 22 is formed by forming the anode active material layer 22B on the anode current collector 22A.

Next, the cathode lead 25 is attached to the cathode current collector 21A by welding or the like, and the anode lead 26 is attached to the anode current collector 22A by welding or the like. Subsequently, the cathode 21 and the anode 22 are wound with the separator 23 in between. The end of the cathode lead 25 is welded to the safety valve mechanism 15, and the end of the anode lead 26 is welded to the battery can 11. The wound cathode 21 and the wound anode 22 are sandwiched between the pair of insulating plates 12 and 13, and contained inside the battery can 11. After the cathode 21 and the anode 22 are contained inside the battery can 11, an electrolytic solution is injected into the battery can 11 and impregnated in the separator 23. After that, at the open end of the battery can 11, the battery cover 14, the safety valve mechanism 15, and the PTC device 16 are fixed by being caulked with the gasket 17. The secondary battery shown in FIGS. 1 and 2 is thereby completed.

In the secondary battery, when charged, for example, lithium ions are extracted from the cathode 21 and inserted in the anode 22 through the electrolytic solution. When discharged, for example, lithium ions are extracted from the anode 22, and inserted in the cathode 21 through the electrolytic solution. Then, since LiN(CₙF₂ₙ₊₁SO₂)(CₘF₂ₘ₊₁SO₂) is contained in the electrolytic solution, a coat stable even at high temperatures can be formed on the surface of the cathode 21 and the anode 22. Therefore, decomposition reaction of the electrolytic solution at high temperatures can be inhibited.

As above, according to this embodiment, since LiN(CₙF₂ₙ₊₁SO₂)(CₘF₂ₘ₊₁SO₂) is contained in the electrolytic solution, a coat stable even at high temperatures can be formed on the surface of the cathode 21 or the anode 22. Therefore, chemical stability of the electrolytic solution at high temperatures can be improved, and high temperature characteristics such as high temperature cycle characteristics can be improved.

In particular, when the content of LiN(CₙF₂ₙ₊₁SO₂)(CₘF₂ₘ₊₁SO₂) in the electrolytic solution is in the range from 0.01 mol/l to 1.5 mol/l, or lithium hexafluorophosphate is further contained in the electrolytic solution, higher characteristics can be obtained.

Further, when the anode material containing the foregoing second element and the foregoing third element in addition to tin is used, or specially, the SnCoC-containing material which contains tin, cobalt, and carbon as an element and has the contents thereof in the foregoing range is used for the anode 22, higher characteristics can be obtained.

### Second Embodiment

A secondary battery according to a second embodiment has a structure, action, and effects similar to of the first embodiment, except that the structure of the anode 22 is different, and can be similarly manufactured. Therefore, descriptions will be given with reference to FIG. 1 and FIG. 2 by using the same symbols for the corresponding components. Descriptions of the same components will be omitted.

The anode 22 has a structure in which the anode active material layer 22B is provided on the both faces of the anode current collector 22A similarly to of the first embodiment. The anode active material layer 22B contains an anode active material containing at least one of silicon and tin. Specifically, for example, the anode active material layer 22B contains a simple substance, an alloy, or a compound of silicon, or a simple substance, an alloy, or a compound of tin. The anode active material layer 22B may contain two or more thereof.

The anode active material layer 22B may be formed by using, for example, vapor-phase deposition method, liquid-phase deposition method, firing method, or two or more of these methods. The anode active material layer 22B and the anode current collector 22A are preferably alloyed at the interface thereof at least in part. Specifically, it is preferable that at the interface thereof, the element of the anode current collector 22A is diffused in the anode active material layer 22B, or the element of the anode active material is diffused in the anode current collector 22A, or both elements are diffused therein. Thereby, deconstruction due to expansion and shrinkage of the anode active material layer 22B according to charge and discharge can be inhibited, and electron conductivity between the anode active material layer 22B and the anode current collector 22A can be improved.

As vapor-phase deposition method, for example, physical deposition method or chemical deposition method can be used. Specifically, vacuum vapor deposition method, sputtering method, ion plating method, laser ablation method, thermal CVD (Chemical Vapor Deposition) method, plasma CVD method, spraying method and the like can be cited. As liquid-phase deposition method, a known technique such as electrolytic plating and electroless plating can be used. Firing method is, for example, a method in which a particulate anode active material, a binder and the like are mixed and dispersed in a solvent, the anode current collector 22A is coated with the mixture, and the resultant is heat-treated at temperatures higher than the melting point of the binder and the like. For firing method, a known technique such as atmosphere firing method, reactive firing method, and hot press firing method is available.

### Third Embodiment

A secondary battery according to a third embodiment is a so-called lithium metal secondary battery in which the capacity of the anode 22 is expressed by the capacity component due to precipitation and dissolution of lithium. The secondary battery has a structure similar to of the first embodiment, except that the anode active material layer 22B is made of lithium metal, and can be similarly manufactured. Therefore, descriptions will be given by using the same symbols for the corresponding components with reference to FIG. 1 and FIG. 2. Descriptions of the same components will be omitted.

That is, in the secondary battery, lithium metal is used as an anode active material, and thereby a high energy density can be obtained. The anode active material layer 22B may already exist when the battery is assembled. Otherwise, it is possible that the anode active material layer 22B does not exist when the battery is assembled, and is made of lithium metal to be precipitated when the battery is charged. Otherwise, it is possible that the anode active material layer 22B is utilized as a current collector as well and the anode current collector 22A is omitted.

In the secondary battery, when charged, for example, lithium ions are extracted from the cathode 21 and precipitated as lithium metal on the surface of the anode current collector 22A through the electrolytic solution. When discharged, for example, lithium metal is eluted as lithium ions from the anode active material layer 22B, and inserted in the cathode 21 through the electrolytic solution. As above, in the secondary battery, precipitation and dissolution of lithium metal are repeated in the anode 22. Therefore, activity of the anode 22 is significantly high. However, in this embodiment, a coat stable even at high temperatures is formed on the surface of the anode 22. Therefore, superior high temperature cycle characteristics can be obtained.

### Fourth Embodiment

A secondary battery according to a fourth embodiment is a secondary battery in which the anode capacity includes the capacity component due to insertion and extraction of lithium as an electrode reactant and the capacity component due to precipitation and dissolution of lithium, and is expressed by the sum thereof. The secondary battery has a structure similar to of the first secondary battery, except that the structure of the anode active material layer 22B is different, and can be similarly manufactured. Therefore, descriptions will be given by using the same symbols for the corresponding components with reference to FIG. 1 and FIG. 2. Descriptions of the same components will be omitted.

The anode active material layer 22B contains, as an anode active material, one or more anode materials capable of inserting and extracting lithium. The anode active material layer 22B may contain a binder according to needs. As such an anode material, for example, a carbon material, or a material containing a metal element or a metalloid element capable of forming an alloy with lithium as an element as described in the first embodiment can be cited. Specially, the carbon material is preferably used, since superior cycle characteristics can be obtained.

The amount of the anode material capable of inserting and extracting lithium is adjusted so that the charging capacity by the anode material is smaller than the charging capacity of the cathode 21. Therefore, in the secondary battery, in the process of charging, lithium metal begins to be precipitated on the anode 22 when the open circuit voltage (that is, battery voltage) is lower than the overcharge voltage.

The overcharge voltage means the open circuit voltage when the battery becomes in an overcharge state. For example, the overcharge voltage means a higher voltage than the open circuit voltage of the battery, which is “fully charged,” described in and defined by “Guidelines for Safety Assessment of lithium secondary batteries” (SBA G1101), which is one of guidelines specified by Japan Storage Battery Industries Incorporated (Battery Association of Japan). In other words, the overcharge voltage means a higher voltage than the open circuit voltage after charge by using charging method used in obtaining nominal capacity of each battery, standard charging method, or recommended charging method. For example, in the case that it is fully charged when the open circuit voltage is 4.2 V, lithium metal is precipitated on the surface of the anode material capable of inserting and extracting lithium in part of the open circuit voltage from 0 V to 4.2 V. Therefore, in the secondary battery, both the anode material capable of inserting and extracting lithium and the lithium metal function as an anode active material, and the anode material capable of inserting and extracting lithium is a base material when the lithium metal is precipitated. Thereby, in the secondary battery, a high energy density can be obtained, and in addition, cycle characteristics and rapid charge characteristics can be improved.

In the secondary battery, when charged, lithium ions are extracted from the cathode 21, and firstly inserted in the anode material capable of inserting and extracting lithium contained in the anode 22 through the electrolytic solution. When further charged, in a state that the open circuit voltage is lower than the overcharge voltage, lithium metal begins to be precipitated on the surface of the anode material capable of inserting and extracting lithium. After that, until charge is finished, lithium metal continues to be precipitated on the anode 22. Next, when discharged, first, lithium metal precipitated on the anode 22 is eluted as ions, which are inserted in the cathode 21 through the electrolytic solution. When further discharged, lithium ions are extracted from the anode material capable of inserting and extracting lithium in the anode 22, and inserted in the cathode 21 through the electrolytic solution. As above, since in the secondary battery, precipitation and dissolution of lithium metal in the anode 22 are repeated, activity of the anode 22 is significantly high. However, in this embodiment, a coat stable even at high temperatures is formed on the surface of the anode 22. Therefore, superior high temperature cycle characteristics can be obtained.

### Fifth Embodiment

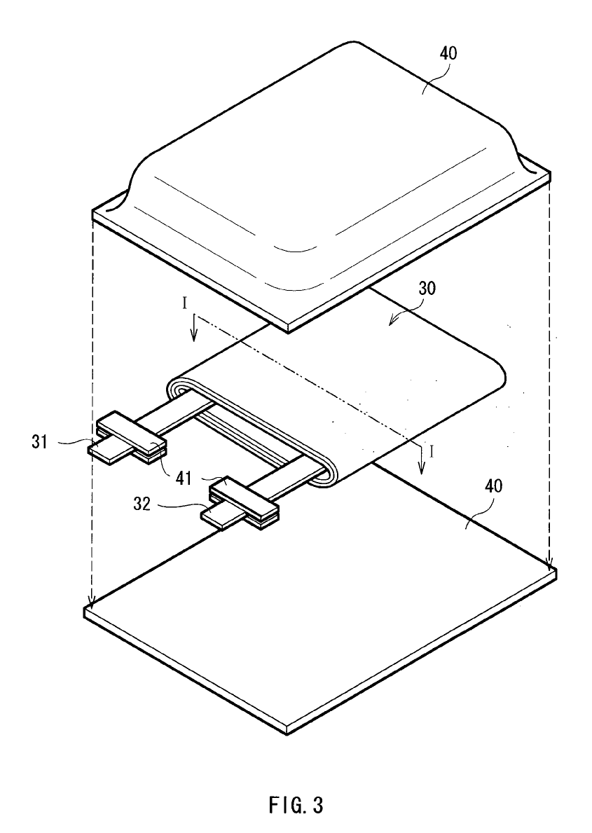

FIG. 3 shows a structure of a secondary battery according to a fifth embodiment. The secondary battery is a so-called laminated film type secondary battery. In the secondary battery, a spirally wound electrode body 30 on which a cathode lead 31 and an anode lead 32 are attached is contained inside a film package member 40.

The cathode lead 31 and the anode lead 32 are respectively directed from inside to outside of the package member 40 in the same direction, for example. The cathode lead 31 and the anode lead 32 are respectively made of, for example, a metal material such as aluminum, copper, nickel, and stainless, and are in the shape of thin plate or mesh.

The package member 40 is made of a rectangular aluminum laminated film in which, for example, a nylon film, an aluminum foil, and a polyethylene film are bonded together in this order. The package member 40 is, for example, arranged so that the polyethylene film side and the spirally wound electrode body 30 are opposed, and the respective outer edges are contacted to each other by fusion bonding or an adhesive. Adhesive films 41 to protect from outside air intrusion are inserted between the package member 40 and the cathode lead 31, the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The exterior member 40 may be made of a laminated film having other structure, a high molecular weight film such as polypropylene, or a metal film, instead of the foregoing aluminum laminated film.

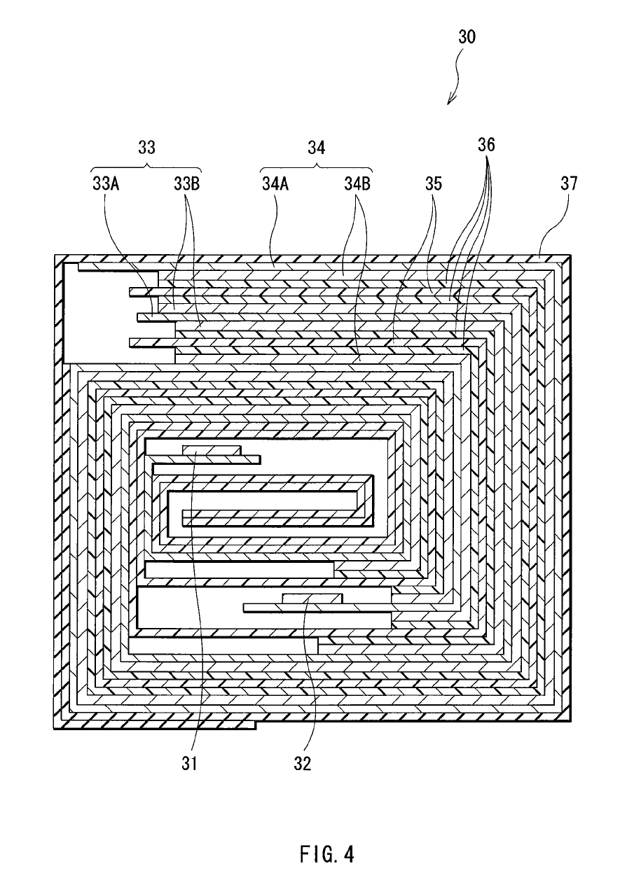

FIG. 4 shows a cross sectional structure taken along line I-I of the spirally wound electrode body 30 shown in FIG. 3. In the spirally wound electrode body 30, a pair of a cathode 33 and an anode 34 is layered with a separator 35 and an electrolyte layer 36 in between and wound. The outermost periphery thereof is protected by a protective tape 37.

The cathode 33 has a structure in which a cathode active material layer 33B is provided on the both faces of a cathode current collector 33A. The anode 34 has a structure in which an anode active material layer 34B is provided on the both faces of an anode current collector 34A. Arrangement is made so that the anode active material layer 34B is opposed to the cathode active material layer 33B. The structures of the cathode current collector 33A, the cathode active material layer 33B, the anode current collector 34A, the anode active material layer 34B, and the separator 35 are similar to of the cathode current collector 21A, the cathode active material layer 21B, the anode current collector 22A, the anode active material layer 22B, and the separator 23 respectively hereinbefore described in the first to the forth embodiments.

The electrolyte layer 36 is so-called gelatinous, containing an electrolytic solution and a high molecular weight compound to become a holding body, which holds the electrolytic solution. The gelatinous electrolyte is preferable, since high ion conductivity can be obtained and liquid leakage of the battery can be prevented. The structure of the electrolytic solution is similar to of the first embodiment. As a high molecular weight compound, for example, an ether high molecular weight compound such as polyethylene oxide and a cross-linked body containing polyethylene oxide; an ester high molecular weight compound such as polymethacrylate or an acrylate high molecular weight compound; or a polymer of vinylidene fluoride such as polyvinylidene fluoride and a copolymer of vinylidene fluoride and hexafluoropropylene can be cited. One thereof or a mixture of two or more thereof is used. In particular, in view of redox stability, a fluorinated high molecular weight compound such as a polymer of vinylidene fluoride is desirably used.

The secondary battery can be manufactured, for example, as follows.

First, the cathode 33 and the anode 34 are respectively coated with a precursor solution containing an electrolytic solution, a high molecular weight compound, and a mixed solvent. The mixed solvent is volatilized to form the electrolyte layer 36. Next, the cathode lead 31 is attached to the cathode current collector 33A, and the anode lead 32 is attached to the anode current collector 34A. Subsequently, the cathode 33 and the anode 34 formed with the electrolyte layer 36 are layered with the separator 35 in between to obtain a lamination. After that, the lamination is wound in the longitudinal direction, the protective tape 37 is adhered to the outermost periphery thereof to form the spirally wound electrode body 30. After that, for example, the spirally wound electrode body 30 is sandwiched between the package members 40, and outer edges of the exterior members 40 are contacted by thermal fusion bonding or the like to enclose the spirally wound electrode body 30. Then, the adhesive films 41 are inserted between the cathode lead 31, the anode lead 32 and the exterior member 40. Thereby, the secondary battery shown in FIGS. 3 and 4 is completed.

Otherwise, the secondary battery may be fabricated as follows. First, the cathode 33 and the anode 34 are formed as described above, and the cathode lead 31 and the anode lead 32 are attached on the cathode 33 and the anode 34. After that, the cathode 33 and the anode 34 are layered with the separator 35 in between and wound. The protective tape 37 is adhered to the outermost periphery thereof, and a spirally wound body as a precursor of the spirally wound electrode body 30 is formed. Next, the spirally wound body is sandwiched between the exterior members 40, the peripheral edges except for one side are thermally fusion-bonded to obtain a pouched state, and the spirally wound body is contained inside the exterior member 40. Subsequently, an electrolytic composition containing an electrolytic solution, a monomer as a raw material for a high molecular weight compound, a polymerization initiator, and if necessary other material such as a polymerization inhibitor is prepared, which is injected into the package member 40. After that, the opening of the package member 40 is thermally fusion-bonded and hermetically sealed. After that, the resultant is heated to polymerize the monomer to obtain a high molecular weight compound. Thereby, the gelatinous electrolyte layer 36 is formed, and the secondary battery shown in FIGS. 3 and 4 is assembled.

The secondary battery works in the same manner as the secondary batteries according to the first to the fourth embodiments, and similar effects can be obtained.

### Sixth Embodiment

A secondary battery according to a sixth embodiment has a structure similar to of the secondary batteries according to the first to the fifth embodiments, except that the open circuit voltage in full charge (that is, the battery voltage) is in the range from 4.25 V to 6.00 V by adjusting the amounts of the cathode active material and the anode active material, and can be similarly manufactured.

In the secondary battery, the lithium extraction amount per unit weight is larger than in the battery in which the open circuit voltage in full charge is 4.20 V even when the same cathode active material is used. Accordingly, the amounts of the cathode active material and the anode active material are adjusted, and thereby a high energy density can be obtained.

As above, according to this embodiment, the battery voltage when charged is 4.25 V or more. Therefore, the electrolytic solution in the cathode is subject to be decomposed. However, since LiN(CₙF₂ₙ₊₁SO₂)(CₘF₂ₘ₊₁SO₂) is contained in the electrolytic solution, a coat stable even at high temperatures can be formed on the surface of the cathode. Consequently, superior high temperature cycle characteristics can be obtained.

### EXAMPLES

Further, specific examples of the present invention will be described in detail.

### Examples 1-1 to 1-6

Cylindrical secondary batteries shown in FIGS. 1 and 2 were fabricated. First, lithium carbonate (Li₂CO₃) and cobalt carbonate (CoCO₃) were mixed at a mol ratio of 0.5:1. The mixture was fired for 5 hours at 890 deg C. in the air to obtain lithium-cobalt complex oxide (LiCoO₂). The obtained LiCoO₂ was provided with X-ray diffraction. The result well accorded with the peak of LiCoO₂ registered in the JCPDS (Joint Committee of Powder Diffraction Standard) file. Subsequently, the lithium-cobalt complex oxide was pulverized to obtain powder with an average particle diameter of 10 μm as a cathode active material.

Next, 95 parts by weight of LiCoO₂, 5 parts by weight of Li₂CO₃ powder, 91 parts by weight of the mixture thereof, 6 parts by weight of artificial graphite as an electrical conductor (KS-15 made by Lonza), and 3 parts by weight of polyvinylidene fluoride as a binder were mixed. The mixture was dispersed in N-methyl-2-pyrrolidone as a solvent to obtain cathode mixture slurry. Subsequently, the both faces of the cathode current collector 21A made of a strip-shaped aluminum foil being 20 μm thick were uniformly coated with the cathode mixture slurry, which was dried and compression-molded to form the cathode active material layer 21B and thereby forming the cathode 21. After that, the cathode lead 25 made of aluminum was attached to one end of the cathode current collector 21A.

Further, 92 parts by weight of artificial graphite (KS-15 made by Lonza) as an anode active material and 3 parts by weight of polyvinylidene fluoride as a binder were mixed. The mixture was dispersed in N-methyl-2-pyrrolidone as a solvent to obtain anode mixture slurry. Next, the both faces of the anode current collector 22A made of a strip-shaped copper foil being 10 μm thick were uniformly coated with the anode mixture slurry, which was dried and compression-molded to form the anode active material layer 22B and thereby forming the anode 22. Subsequently, the anode lead 26 made of nickel was attached to one end of the anode current collector 22A.

After the cathode 21 and the anode 22 were respectively formed, the separator 23 made of polyethylene being 25 μm thick was prepared. The anode 22, the separator 23, the cathode 21, and the separator 23 were sequentially layered. The lamination was spirally wound several times, the end thereof was fixed by using an adhesive tape to form the spirally wound electrode body 20.

After the spirally wound electrode body 20 was formed, the spirally wound electrode body 20 was sandwiched between the pair of insulating plates 12 and 13. The anode lead 26 was welded to the battery can 11, the cathode lead 25 was welded to the safety valve mechanism 15, and the spirally wound electrode body 20 was contained inside the battery can 11 made of nickel-plated iron. After that, an electrolytic solution was injected into the battery can 11 by depressurization method to fabricate a cylindrical secondary battery being 18 mm in diameter and 65 mm high. For the electrolytic solution, an electrolytic solution obtained by dissolving 0.1 mol/l of an imide salt LiN(CₙF₂ₙ₊₁SO₂)(CₘF₂ₘ₊₁SO₂) and 0.9 mol/l of lithium hexafluorophosphate as an electrolyte salt in a mixed solvent of 40 wt % of ethylene carbonate and 60 wt % of dimethyl carbonate. Then, imide salts were changed in Examples 1-1 to 1-6 as shown in Table 1.

As Comparative example 1-1 relative to Examples 1-1 to 1-6, a secondary battery was fabricated in the same manner as in Examples 1-1 to 1-6, except that the imide salt was not used as an electrolyte salt, and lithium hexafluorophosphate was dissolved so that the content became 1 mol/l. Further, as Comparative examples 1-2 and 1-3, secondary batteries were fabricated in the same manner as in Examples 1-1 to 1-6, except that the imide salt was changed to LiN(CF₃SO₂)₂ or LiN(C₂F₅SO₂)₂.

For the fabricated secondary batteries of Examples 1-1 to 1-6 and Comparative examples 1-1 to 1-3, the cycle characteristics at 25 deg C. and 50 deg C. were examined. The results are shown in Table 1. For the cycle characteristics, 150 cycles of charge and discharge in which after constant current and constant voltage charge of 2500 mA was performed respectively at 25 deg C. or 50 deg C. until the upper voltage of 4.2 V, constant current discharge of 2000 mA was performed until the final voltage of 2.6 V were performed. Then, the discharge capacity retention ratio (%) at the 150th cycle where the discharge capacity at the first cycle was 100 was obtained.

TABLE 1
Anode active material: Artificial graphite

| | | | | | | Discharge | |
|---|---|---|---|---|---|---|---|
| | | | | | | capacity | |
| | Imide salt | | | | | retention ratio | |
| | | | | Content | LiPF₆ | (%) | |
| | Kind | n | m | (mol/l) | (mol/l) | 25 deg C. | 50 deg C. |
| Example 1-1 | LiN(CF₃SO₂)(C₃F₇SO₂) | 1 | 3 | 0.1 | 0.9 | 84 | 89 |
| Example 1-2 | LiN(CF₃SO₂)(C₂F₅SO₂) | 1 | 2 | | | 85 | 90 |
| Example 1-3 | LiN(C₂F₅SO₂)(C₃F₇SO₂) | 2 | 3 | | | 82 | 84 |
| Example 1-4 | LiN(C₂F₅SO₂)(C₄F₉SO₂) | 1 | 4 | | | 82 | 83 |
| Example 1-5 | LiN(C₂F₅SO₂)(C₄F₉SO₂) | 2 | 4 | | | 81 | 80 |
| Example 1-6 | LiN(C₃F₇SO₂)(C₄F₉SO₂) | 3 | 4 | | | 80 | 78 |
| Comparative | — | — | — | — | 1.0 | 80 | 76 |
| example 1-1 | | | | | | | |
| Comparative | LiN(CF₃SO₂)₂ | 1 | 1 | 0.1 | 0.9 | 80 | 76 |
| example 1-2 | | | | | | | |
| Comparative | LiN(C₂F₅SO₂)₂ | 2 | 2 | | | 80 | 76 |
| example 1-3 | | | | | | | |

As shown in Table 1, according to Examples 1-1 to 1-6, the discharge capacity retention ratio could be improved compared to in Comparative example 1-1 not using the imide salt, and in particular, higher effect could be seen at 50 deg C. Meanwhile, in Comparative examples 1-2 and 1-3 using the imide salt in which n and m were identical, the discharge capacity retention ratio was not improved. That is, it was found that when an imide salt LiN(CₙF₂ₙ₊₁SO₂)(CₘF₂ₘ₊₁SO₂) was contained in the electrolytic solution, cycle characteristics could be improved, and in particular, cycle characteristics at high temperatures could be effectively improved.

### Examples 2-1 to 2-8

Secondary batteries were fabricated in the same manner as in Example 1-1, except that the content of the imide salt LiN(CF₃SO₂)(C₃F₇SO₂) was changed. Then, in Examples 2-1 to 2-6, the imide salt and lithium hexafluorophosphate were used as an electrolyte salt, and each content was changed as shown in Table 2 so that the total content became 1 mol/l. In Examples 2-7 and 2-8, only the imide salt was used as an electrolyte salt, and the content was changed as shown in Table 2.

For the fabricated secondary batteries of Examples 2-1 and 2-8, the cycle characteristics were measured in the same manner as in Example 1-1. The results are shown together with the results of Example 1-1 and Comparative example 1-1 in Table 2.

TABLE 2
Anode active material: Artificial graphite

| | | | | Discharge | |
|---|---|---|---|---|---|
| | | | | capacity | |
| | Imide salt | | | retention ratio | |
| | | Content | | (%) | |
| | Kind | (mol/l) | LiPF₆ (mol/l) | 25 deg C. | 50 deg C. |
| Example 2-1 | LiN(CF₃SO₂)(C₃F₇SO₂) | 0.01 | 0.99 | 80 | 79 |
| Example 2-2 | | 0.05 | 0.95 | 82 | 81 |
| Example 1-1 | | 0.1 | 0.9 | 84 | 89 |
| Example 2-3 | | 0.3 | 0.7 | 85 | 91 |
| Example 2-4 | | 0.5 | 0.5 | 85 | 93 |
| Example 2-5 | | 0.7 | 0.3 | 83 | 91 |
| Example 2-6 | | 0.9 | 0.1 | 82 | 86 |
| Example 2-7 | | 1.0 | 0 | 80 | 82 |
| Example 2-8 | | 1.5 | 0 | 80 | 79 |
| Comparative | — | — | 1.0 | 80 | 76 |
| example 1-1 | | | | | |

As shown in Table 2, when the imide salt content was increased, there was a tendency that the discharge capacity retention ratio was improved, showed the maximum value, and then was decreased. Further, compared to Example 2-7 using only the imide salt, higher characteristics could be obtained in Examples 1-1, 2-3 to 2-6 using the mixture of the imide salt and lithium hexafluorophosphate. That is, it was found that the imide salt content in the electrolytic solution was preferably in the range from 0.01 mol/l to 1.5 mol/l, and higher characteristics could be obtained when the mixture of the imide salt and lithium hexafluorophosphate was used.

### Examples 3-1 to 3-6

Secondary batteries were fabricated in the same manner as in Example 2-4, except that the open circuit voltage in a full charge state is set to be larger than 4.20 V by changing the ratio between the cathode active material and the anode active material. Then, in Examples 3-1 to 3-6, the open circuit voltage in a full charge state was changed to 4.25 V, 4.30 V, 4.40 V, 4.50 V, 4.60 V, or 4.70 V as shown in Table 3. The imide salt was LiN(CF₃SO₂)(C₃F₇SO₂), and the mixture of 0.5 mol/l of the imide salt and 0.5 mol/l of lithium hexafluorophosphate was used.

As respective Comparative examples 3-1 to 3-6 relative to the respective Examples 3-1 to 3-6, secondary batteries were fabricated in the same manner as in the respective Examples 3-1 to 3-6, except that the imide salt was not used and lithium hexafluorophosphate was dissolved so that the content became 1 mol/l.

For the fabricated secondary batteries of Examples 3-1 to 3-6 and Comparative examples 3-1 to 3-6, the cycle characteristics were measured in the same manner as in Example 2-4. The results are shown together with the results of Example 2-4 and Comparative example 1-1 in Table 3. Further, in Table 3, the initial discharge capacity at 25 deg C. is also shown.

TABLE 3
Anode active material: Artificial graphite

| | | | | | Discharge | |
|---|---|---|---|---|---|---|
| | | | | Initial | capacity | |
| | Charging | | | discharge | retention ratio | |
| | voltage | Electrolyte salt (mol/l) | | capacity | (%) | |
| | (V) | LiN(CF₃SO₂)(C₃F₇SO₂) | LiPF₆ | (mAh) | 25 deg C. | 50 deg C. |
| Example 2-4 | 4.20 | 0.5 | 0.5 | 2000 | 85 | 93 |
| Comparative | | — | 1.0 | 2000 | 80 | 76 |
| example 1-1 | | | | | | |
| Example 3-1 | 4.25 | 0.5 | 0.5 | 2050 | 85 | 92 |
| Comparative | | — | 1.0 | 2050 | 79 | 74 |
| example 3-1 | | | | | | |
| Example 3-2 | 4.30 | 0.5 | 0.5 | 2110 | 82 | 87 |
| Comparative | | — | 1.0 | 2110 | 72 | 63 |
| example 3-2 | | | | | | |
| Example 3-3 | 4.40 | 0.5 | 0.5 | 2200 | 80 | 79 |
| Comparative | | — | 1.0 | 2200 | 60 | 20 |
| example 3-3 | | | | | | |
| Example 3-4 | 4.50 | 0.5 | 0.5 | 2305 | 75 | 73 |
| Comparative | | — | 1.0 | 2305 | 40 | 10 |
| example 3-4 | | | | | | |
| Example 3-5 | 4.60 | 0.5 | 0.5 | 2450 | 65 | 60 |
| Comparative | | — | 1.0 | 2450 | 30 | 0 |
| example 3-5 | | | | | | |
| Example 3-6 | 4.70 | 0.5 | 0.5 | 2500 | 30 | 20 |
| Comparative | | — | 1.0 | 2500 | 0 | 0 |
| example 3-6 | | | | | | |

As shown in Table 3, when the battery voltage was increased, there was a tendency that though the discharge capacity was improved, the discharge capacity retention ratio was lowered. However, according to Examples 2-4 and 3-1 to 3-6 in which the imide salt was added, the discharge capacity retention ratio could be improved compared to in Comparative examples 1-1 and 3-1 to 3-6 in which the imide salt was not added, and the effect was higher at 50 deg C. That is, it was found that the imide salt LiN(CₙF₂ₙ₊₁SO₂)(CₘF₂ₘ₊₁SO₂) was contained in the electrolytic solution, cycle characteristics could be improved even in the battery with an increased battery voltage, and in particular, cycle characteristics at high temperatures could be effectively improved.

### Examples 4-1 to 4-8

Secondary batteries were fabricated in the same manner as in Examples 2-4 and 3-1 to 3-6, except that the material of the separator 23 was changed. Then, in Examples 4-1 to 4-4 and 4-6 to 4-8, the separator 23 with a three-layer structure made of polypropylene-polyethylene-polypropylene was used. In Example 4-5, the separator 23 with a three-layer structure made of polyvinylidene fluoride-polyethylene-polyvinylidene fluoride was used. The open circuit voltage in a full charge state was changed to 4.25 V, 4.30 V, 4.40 V, 4.50 V, 4.60 V, or 4.70 V as shown in Table 4 in the same manner as in Examples 2-4 and 3-1 to 3-6. The imide salt was LiN(CF₃SO₂)(C₃F₇SO₂), and the mixture of 0.5 mol/l of the imide salt and 0.5 mol/l of lithium hexafluorophosphate was used.

For the fabricated secondary batteries of Examples 4-1 to 4-8, the cycle characteristics were measured in the same manner as in Examples 2-4 and 3-1 to 3-6. The results are shown together with the results of Examples 2-4 and 3-1 to 3-6 in Table 4.

TABLE 4
Anode active material: Artificial graphite

| | | | Initial | | |
|---|---|---|---|---|---|
| | Charging | | discharge | Discharge capacity | |
| | voltage | | capacity | retention ratio (%) | |
| | (V) | Separator | (mAh) | 25 deg C. | 50 deg C. |
| Example 2-4 | 4.20 | PE | 2000 | 85 | 93 |
| Example 4-1 | | PP/PE/PP | 2000 | 85 | 94 |
| Example 3-1 | 4.25 | PE | 2050 | 85 | 92 |
| Example 4-2 | | PP/PE/PP | 2050 | 85 | 93 |
| Example 3-2 | 4.30 | PE | 2110 | 82 | 87 |
| Example 4-3 | | PP/PE/PP | 2110 | 84 | 90 |
| Example 3-3 | 4.40 | PE | 2200 | 80 | 79 |
| Example 4-4 | | PP/PE/PP | 2200 | 83 | 85 |
| Example 4-5 | | PVdF/PE/ | 2200 | 85 | 87 |
| | | PVdF | | | |
| Example 3-4 | 4.50 | PE | 2305 | 75 | 73 |
| Example 4-6 | | PP/PE/PP | 2305 | 80 | 80 |
| Example 3-5 | 4.60 | PE | 2450 | 65 | 60 |
| Example 4-7 | | PP/PE/PP | 2450 | 70 | 70 |
| Example 3-6 | 4.70 | PE | 2500 | 30 | 20 |
| Example 4-8 | | PP/PE/PP | 2500 | 50 | 45 |

PE: polyethylene
PP: polypropylene
PVdF: polyvinylidene fluoride

As shown in Table 4, compared to Examples 2-4 and 3-1 to 3-6 using the separator 23 made of polyethylene, in Examples 4-1 to 4-8 using the separator 23 with the three-layer structure made of polypropylene-polyethylene-polypropylene or the separator 23 with the three-layer structure made of polyvinylidene fluoride-polyethylene-polyvinylidene fluoride, higher characteristics could be obtained. That is, it was found that cycle characteristics could be further improved when the separator 23 with the three-layer structure made of polypropylene-polyethylene-polypropylene or the separator 23 with the three-layer structure made of polyvinylidene fluoride-polyethylene-polyvinylidene fluoride was used.

### Examples 5-1-1, 5-1-2 to 5-27-1, 5-27-2

In Examples 5-1-1 to 5-27-1, secondary batteries were fabricated in the same manner as in Example 2-4, except that as an anode active material, a material containing tin as a first element was used instead of the carbon material. Further, in Examples 5-1-2 to 5-27-2, secondary batteries were fabricated in the same manner as in Example 2-4, except that as an anode active material, a material containing tin as a first element was used as in Examples 5-1-1 to 5-27-1, and further the composition of the solvent of the electrolytic solution was changed.

The anode active material was synthesized by utilizing mechanochemical reaction. The composition of the anode active material was changed in Examples 5-1-1, 5-1-2 to 5-27-1, 5-27-2 as shown in Tables 5 to 10. Specifically, in Examples 5-1-1, 5-1-2 to 5-21-1, 5-21-2, the second element was changed to cobalt, iron, magnesium, titanium, vanadium, chromium, manganese, nickel, copper, zinc, gallium, zirconium, niobium, molybdenum, silver, indium, cerium, hafnium, tantalum, tungsten, or bismuth, and carbon was used as a third element. In Examples 5-22-1, 5-22-2 to 5-24-1, 5-24-2, cobalt was used as a second element, and the third element was changed to boron, aluminum, or phosphorus. In Examples 5-25-1, 5-25-2 to 5-27-1, 5-27-2, cobalt was used as a second element, carbon was used as a third element, and other elements were further added thereto.

For the obtained anode active material powder, composition analysis was performed. The carbon content was measured by a carbon-sulfur analyzer, and the contents of other elements were measured by ICP (Inductively Coupled Plasma) optical emission spectrometry. The obtained results are shown by using parenthesis in the column of the anode active material of Tables 5 to 10. The numbers shown with slashes in parenthesis represent the contents (wt %) of the foregoing elements sequentially.

The anode 22 was formed as follows. 80 parts by weight of the obtained anode active material powder, 11 parts by weight of artificial graphite (KS-15 made by Lonza) as an electrical conductor, 1 part by weight of acetylene black, and 8 parts by weight of polyvinylidene fluoride as a binder were mixed, and the mixture was dispersed in N-methyl-2-pyrrolidone as a solvent. The anode current collector 22A was coated with the resultant to form the anode active material layer 22B.

Further, the solvent used in Examples 5-1-2 to 5-27-2 was prepared by mixing 20 wt % of 4-fluoro-1,3-dioxolane-2-one, 20 wt % of ethylene carbonate, and 60 wt % of dimethyl carbonate. The imide salt used in Examples 5-1-1, 5-1-2 to 5-27-1, 5-27-2 was LiN(CF₃SO₂)(C₃F₇SO₂), and the mixture of 0.5 mol/l of the imide salt and 0.5 mol/l of lithium hexafluorophosphate was used as an electrolyte salt.

As respective Comparative examples relative to the respective Examples, secondary batteries were fabricated in the same manner as in the respective Examples, except that as an electrolyte salt, the imide salt was not used, and lithium hexafluorophosphate was dissolved so that the content became 1 mol/l. For the fabricated secondary batteries of the respective Examples and the respective Comparative examples, the cycle characteristics were measure in the same manner as in Example 2-4. The results are shown in Tables 5 to 10.

TABLE 5

| | | Composition | | | | | Discharge | |
|---|---|---|---|---|---|---|---|---|
| | | of | | | | | capacity | |
| | Anode active | solvent | | | | | retention ratio | |
| | material | (wt %) | | | Electrolyte salt (mol/l) | | (%) | |
| | (wt %) | FEC | EC | DMC | LiPF₆ | LiN(CF₃SO₂)(C₃F₇SO₂) | 25 deg C. | 50 deg C. |
| Example 5-1-1 | Sn—Co—C | — | 40 | 60 | 0.5 | 0.5 | 61 | 57 |
| Example 5-1-2 | (50/29.4/19.6) | 20 | 20 | 60 | 0.5 | 0.5 | 91 | 92 |
| Comparative | | — | 40 | 60 | 1.0 | — | 60 | 52 |
| example 5-1-1 | | | | | | | | |
| Comparative | | 20 | 20 | 60 | 1.0 | — | 90 | 84 |
| example 5-1-2 | | | | | | | | |
| Example 5-2-1 | Sn—Fe—C | — | 40 | 60 | 0.5 | 0.5 | 68 | 64 |
| Example 5-2-2 | (50/29.4/19.6) | 20 | 20 | 60 | 0.5 | 0.5 | 88 | 88 |
| Comparative | | — | 40 | 60 | 1.0 | — | 50 | 42 |
| example 5-2-1 | | | | | | | | |
| Comparative | | 20 | 20 | 60 | 1.0 | — | 78 | 71 |
| example 5-2-2 | | | | | | | | |
| Example 5-3-1 | Sn—Mg—C | — | 40 | 60 | 0.5 | 0.5 | 52 | 47 |
| Example 5-3-2 | (50/29.4/19.6) | 20 | 20 | 60 | 0.5 | 0.5 | 82 | 83 |
| Comparative | | — | 40 | 60 | 1.0 | — | 51 | 43 |
| example 5-3-1 | | | | | | | | |
| Comparative | | 20 | 20 | 60 | 1.0 | — | 80 | 74 |
| example 5-3-2 | | | | | | | | |
| Example 5-4-1 | Sn—Ti—C | — | 40 | 60 | 0.5 | 0.5 | 65 | 57 |
| Example 5-4-2 | (50/29.4/19.6) | 20 | 20 | 60 | 0.5 | 0.5 | 90 | 90 |
| Comparative | | — | 40 | 60 | 1.0 | — | 60 | 52 |
| example 5-4-1 | | | | | | | | |
| Comparative | | 20 | 20 | 60 | 1.0 | — | 90 | 84 |
| example 5-4-2 | | | | | | | | |
| Example 5-5-1 | Sn—V—C | — | 40 | 60 | 0.5 | 0.5 | 54 | 46 |
| Example 5-5-2 | (50/29.4/19.6) | 20 | 20 | 60 | 0.5 | 0.5 | 79 | 79 |
| Comparative | | — | 40 | 60 | 1.0 | — | 50 | 42 |
| example 5-5-1 | | | | | | | | |
| Comparative | | 20 | 20 | 60 | 1.0 | — | 78 | 72 |
| example 5-5-2 | | | | | | | | |

FEC: 4-fluoro-1,3-dioxolane-2-one
EC: ethylene carbonate
DMC: dimethyl carbonate

TABLE 6

| | | Composition | | | | | Discharge | |
|---|---|---|---|---|---|---|---|---|
| | | of | | | | | capacity | |
| | Anode active | solvent | | | | | retention | |
| | material | (wt %) | | | Electrolyte salt (mol/l) | | ratio (%) | |
| | (wt %) | FEC | EC | DMC | LiPF₆ | LiN(CF₃SO₂)(C₃F₇SO₂) | 25 deg C. | 50 deg C. |
| Example 5-6-1 | Sn—Cr—C | — | 40 | 60 | 0.5 | 0.5 | 56 | 48 |
| Example 5-6-2 | (50/29.4/19.6) | 20 | 20 | 60 | 0.5 | 0.5 | 80 | 80 |
| Comparative | | — | 40 | 60 | 1.0 | — | 52 | 44 |
| example 5-6-1 | | | | | | | | |
| Comparative | | 20 | 20 | 60 | 1.0 | — | 78 | 71 |
| example 5-6-2 | | | | | | | | |
| Example 5-7-1 | Sn—Mn—C | — | 40 | 60 | 0.5 | 0.5 | 51 | 48 |
| Example 5-7-2 | (50/29.4/19.6) | 20 | 20 | 60 | 0.5 | 0.5 | 76 | 77 |
| Comparative | | — | 40 | 60 | 1.0 | — | 49 | 42 |
| example 5-7-1 | | | | | | | | |
| Comparative | | 20 | 20 | 60 | 1.0 | — | 75 | 69 |
| example 5-7-2 | | | | | | | | |
| Example 5-8-1 | Sn—Ni—C | — | 40 | 60 | 0.5 | 0.5 | 54 | 47 |
| Example 5-8-2 | (50/29.4/19.6) | 20 | 20 | 60 | 0.5 | 0.5 | 81 | 81 |
| Comparative | | — | 40 | 60 | 1.0 | — | 52 | 43 |
| example 5-8-1 | | | | | | | | |
| Comparative | | 20 | 20 | 60 | 1.0 | — | 79 | 73 |
| example 5-8-2 | | | | | | | | |
| Example 5-9-1 | Sn—Cu—C | — | 40 | 60 | 0.5 | 0.5 | 56 | 50 |
| Example 5-9-2 | (50/29.4/19.6) | 20 | 20 | 60 | 0.5 | 0.5 | 85 | 85 |
| Comparative | | — | 40 | 60 | 1.0 | — | 54 | 46 |
| example 5-9-1 | | | | | | | | |
| Comparative | | 20 | 20 | 60 | 1.0 | — | 84 | 78 |
| example 5-9-2 | | | | | | | | |
| Example 5-10-1 | Sn—Zn—C | — | 40 | 60 | 0.5 | 0.5 | 53 | 50 |
| Example 5-10-2 | (50/29.4/19.6) | 20 | 20 | 60 | 0.5 | 0.5 | 79 | 79 |
| Comparative | | — | 40 | 60 | 1.0 | — | 51 | 43 |
| example 5-10-1 | | | | | | | | |
| Comparative | | 20 | 20 | 60 | 1.0 | — | 71 | 71 |
| example 5-10-2 | | | | | | | | |

FEC: 4-fluoro-1,3-dioxolane-2-one
EC: ethylene carbonate
DMC: dimethyl carbonate

TABLE 7

| | | Composition | | | | | Discharge | |
|---|---|---|---|---|---|---|---|---|
| | | of | | | | | capacity | |
| | Anode active | solvent | | | | | retention | |
| | material | (wt %) | | | Electrolyte salt (mol/l) | | ratio (%) | |
| | (wt %) | FEC | EC | DMC | LiPF₆ | LiN(CF₃SO₂)(C₃F₇SO₂) | 25 deg C. | 50 deg C. |
| Example 5-11-1 | Sn—Ga—C | — | 40 | 60 | 0.5 | 0.5 | 52 | 49 |
| Example 5-11-2 | (50/29.4/19.6) | 20 | 20 | 60 | 0.5 | 0.5 | 78 | 78 |
| Comparative | | — | 40 | 60 | 1.0 | — | 50 | 42 |
| example 5-11-1 | | | | | | | | |
| Comparative | | 20 | 20 | 60 | 1.0 | — | 77 | 71 |
| example 5-11-2 | | | | | | | | |
| Example 5-12-1 | Sn—Zr—C | — | 40 | 60 | 0.5 | 0.5 | 53 | 49 |
| Example 5-12-2 | (50/29.4/19.6) | 20 | 20 | 60 | 0.5 | 0.5 | 80 | 80 |
| Comparative | | — | 40 | 60 | 1.0 | — | 52 | 42 |
| example 5-12-1 | | | | | | | | |
| Comparative | | 20 | 20 | 60 | 1.0 | — | 78 | 72 |
| example 5-12-2 | | | | | | | | |
| Example 5-13-1 | Sn—Nb—C | — | 40 | 60 | 0.5 | 0.5 | 54 | 50 |
| Example 5-13-2 | (50/29.4/19.6) | 20 | 20 | 60 | 0.5 | 0.5 | 80 | 81 |
| Comparative | | — | 40 | 60 | 1.0 | — | 52 | 44 |
| example 5-13-1 | | | | | | | | |
| Comparative | | 20 | 20 | 60 | 1.0 | — | 78 | 71 |
| example 5-13-2 | | | | | | | | |
| Example 5-14-1 | Sn—Mo—C | — | 40 | 60 | 0.5 | 0.5 | 53 | 49 |
| Example 5-14-2 | (50/29.4/19.6) | 20 | 20 | 60 | 0.5 | 0.5 | 79 | 80 |
| Comparative | | — | 40 | 60 | 1.0 | — | 50 | 42 |
| example 5-14-1 | | | | | | | | |
| Comparative | | 20 | 20 | 60 | 1.0 | — | 77 | 72 |
| example 5-14-2 | | | | | | | | |
| Example 5-15-1 | Sn—Ag—C | — | 40 | 60 | 0.5 | 0.5 | 54 | 50 |
| Example 5-15-2 | (50/29.4/19.6) | 20 | 20 | 60 | 0.5 | 0.5 | 80 | 80 |
| Comparative | | — | 40 | 60 | 1.0 | — | 52 | 43 |
| example 5-15-1 | | | | | | | | |
| Comparative | | 20 | 20 | 60 | 1.0 | — | 78 | 72 |
| example 5-15-2 | | | | | | | | |

FEC: 4-fluoro-1,3-dioxolane-2-one
EC: ethylene carbonate
DMC: dimethyl carbonate

TABLE 8

| | | Composition | | | | | Discharge | |
|---|---|---|---|---|---|---|---|---|
| | | of | | | | | capacity | |
| | Anode active | solvent | | | | | retention | |
| | material | (wt %) | | | Electrolyte salt (mol/l) | | ratio (%) | |
| | (wt %) | FEC | EC | DMC | LiPF₆ | LiN(CF₃SO₂)(C₃F₇SO₂) | 25 deg C. | 50 deg C. |
| Example 5-16-1 | Sn—In—C | — | 40 | 60 | 0.5 | 0.5 | 55 | 53 |
| Example 5-16-2 | (50/29.4/19.6) | 20 | 20 | 60 | 0.5 | 0.5 | 87 | 89 |
| Comparative | | — | 40 | 60 | 1.0 | — | 55 | 46 |
| example 5-16-1 | | | | | | | | |
| Comparative | | 20 | 20 | 60 | 1.0 | — | 85 | 79 |
| example 5-16-2 | | | | | | | | |
| Example 5-17-1 | Sn—Ce—C | — | 40 | 60 | 0.5 | 0.5 | 52 | 49 |
| Example 5-17-2 | (50/29.4/19.6) | 20 | 20 | 60 | 0.5 | 0.5 | 79 | 79 |
| Comparative | | — | 40 | 60 | 1.0 | — | 49 | 42 |
| example 5-17-1 | | | | | | | | |
| Comparative | | 20 | 20 | 60 | 1.0 | — | 77 | 71 |
| example 5-17-2 | | | | | | | | |
| Example 5-18-1 | Sn—Hf—C | — | 40 | 60 | 0.5 | 0.5 | 51 | 49 |
| Example 5-18-2 | (50/29.4/19.6) | 20 | 20 | 60 | 0.5 | 0.5 | 78 | 78 |
| Comparative | | — | 40 | 60 | 1.0 | — | 50 | 42 |
| example 5-18-1 | | | | | | | | |
| Comparative | | 20 | 20 | 60 | 1.0 | — | 76 | 70 |
| example 5-18-2 | | | | | | | | |
| Example 5-19-1 | Sn—Ta—C | — | 40 | 60 | 0.5 | 0.5 | 50 | 47 |
| Example 5-19-2 | (50/29.4/19.6) | 20 | 20 | 60 | 0.5 | 0.5 | 77 | 76 |
| Comparative | | — | 40 | 60 | 1.0 | — | 48 | 41 |
| example 5-19-1 | | | | | | | | |
| Comparative | | 20 | 20 | 60 | 1.0 | — | 76 | 70 |
| example 5-19-2 | | | | | | | | |
| Example 5-20-1 | Sn—W—C | — | 40 | 60 | 0.5 | 0.5 | 50 | 46 |
| Example 5-20-2 | (50/29.4/19.6) | 20 | 20 | 60 | 0.5 | 0.5 | 77 | 77 |
| Comparative | | — | 40 | 60 | 1.0 | — | 48 | 40 |
| example 5-20-1 | | | | | | | | |
| Comparative | | 20 | 20 | 60 | 1.0 | — | 75 | 70 |
| example 5-20-2 | | | | | | | | |

FEC: 4-fluoro-1,3-dioxolane-2-one
EC: ethylene carbonate
DMC: dimethyl carbonate

TABLE 9

| | | Composition | | | | | Discharge | |
|---|---|---|---|---|---|---|---|---|
| | | of | | | | | capacity | |
| | Anode active | solvent | | | | | retention | |
| | material | (wt %) | | | Electrolyte salt (mol/l) | | ratio (%) | |
| | (wt %) | FEC | EC | DMC | LiPF₆ | LiN(CF₃SO₂)(C₃F₇SO₂) | 25 deg C. | 50 deg C. |
| Example 5-21-1 | Sn—Bi—C | — | 40 | 60 | 0.5 | 0.5 | 51 | 47 |
| Example 5-21-2 | (50/29.4/19.6) | 20 | 20 | 60 | 0.5 | 0.5 | 77 | 78 |
| Comparative | | — | 40 | 60 | 1.0 | — | 49 | 41 |
| example 5-21-1 | | | | | | | | |
| Comparative | | 20 | 20 | 60 | 1.0 | — | 76 | 71 |
| example 5-21-2 | | | | | | | | |
| Example 5-22-1 | Sn—Co—B | — | 40 | 60 | 0.5 | 0.5 | 41 | 36 |
| Example 5-22-2 | (50/29.4/19.6) | 20 | 20 | 60 | 0.5 | 0.5 | 72 | 74 |
| Comparative | | — | 40 | 60 | 1.0 | — | 40 | 32 |
| example 5-22-1 | | | | | | | | |
| Comparative | | 20 | 20 | 60 | 1.0 | — | 71 | 64 |
| example 5-22-2 | | | | | | | | |
| Example 5-23-1 | Sn—Co—Al | — | 40 | 60 | 0.5 | 0.5 | 43 | 37 |
| Example 5-23-2 | (50/29.4/19.6) | 20 | 20 | 60 | 0.5 | 0.5 | 75 | 74 |
| Comparative | | — | 40 | 60 | 1.0 | — | 42 | 33 |
| example 5-23-1 | | | | | | | | |
| Comparative | | 20 | 20 | 60 | 1.0 | — | 73 | 67 |
| example 5-23-2 | | | | | | | | |
| Example 5-24-1 | Sn—Co—P | — | 40 | 60 | 0.5 | 0.5 | 43 | 37 |
| Example 5-24-2 | (50/29.4/19.6) | 20 | 20 | 60 | 0.5 | 0.5 | 76 | 76 |
| Comparative | | — | 40 | 60 | 1.0 | — | 42 | 33 |
| example 5-24-1 | | | | | | | | |
| Comparative | | 20 | 20 | 60 | 1.0 | — | 74 | 68 |
| example 5-24-2 | | | | | | | | |

FEC: 4-fluoro-1,3-dioxolane-2-one
EC: ethylene carbonate
DMC: dimethyl carbonate

TABLE 10

| | | Composition | | | | | Discharge | |
|---|---|---|---|---|---|---|---|---|
| | | of | | | | | capacity | |
| | Anode active | solvent | | | | | retention | |
| | material | (wt %) | | | Electrolyte salt (mol/l) | | ratio (%) | |
| | (wt %) | FEC | EC | DMC | LiPF₆ | LiN(CF₃SO₂)(C₃F₇SO₂) | 25 deg C. | 50 deg C. |
| Example 5-25-1 | Sn—Co—In—C | — | 40 | 60 | 0.5 | 0.5 | 67 | 63 |
| Example 5-25-2 | (50/24.4/5/19.6) | 20 | 20 | 60 | 0.5 | 0.5 | 95 | 95 |
| Comparative | | — | 40 | 60 | 1.0 | — | 64 | 56 |
| example 5-25-1 | | | | | | | | |
| Comparative | | 20 | 20 | 60 | 1.0 | — | 92 | 86 |
| example 5-25-2 | | | | | | | | |
| Example 5-26-1 | Sn—Co—In—Ti—C | — | 40 | 60 | 0.5 | 0.5 | 74 | 78 |
| Example 5-26-2 | (49/23.4/5/2/19.6) | 20 | 20 | 60 | 0.5 | 0.5 | 96 | 96 |
| Comparative | | — | 40 | 60 | 1.0 | — | 70 | 72 |
| example 5-26-1 | | | | | | | | |
| Comparative | | 20 | 20 | 60 | 1.0 | — | 94 | 88 |
| example 5-26-2 | | | | | | | | |
| Example 5-27-1 | Sn—Si—Co—C | — | 40 | 60 | 0.5 | 0.5 | 60 | 57 |
| Example 5-27-2 | (48/3.9/27.5/19.6) | 20 | 20 | 60 | 0.5 | 0.5 | 87 | 87 |
| Comparative | | — | 40 | 60 | 1.0 | — | 55 | 46 |
| example 5-27-1 | | | | | | | | |
| Comparative | | 20 | 20 | 60 | 1.0 | — | 85 | 79 |
| example 5-27-2 | | | | | | | | |

FEC: 4-fluoro-1,3-dioxolane-2-one
EC: ethylene carbonate
DMC: dimethyl carbonate

As shown in Tables 5 to 10, according to the respective Examples, the discharge capacity retention ratio could be improved compared to in the respective Comparative examples not using the imide salt, and in particular, higher effect was shown at 50 deg C. Further, when 4-fluoro-1,3-dioxolane-2-one was used as a solvent, higher characteristics could be obtained. That is, it was found that as long as the imide salt LiN(CₙF₂ₙ₊₁SO₂)(CₘF₂ₘ₊₁SO₂) was contained in the electrolytic solution, cycle characteristics could be improved even when the anode material containing at least one of silicon and tin as an anode active material was used, and in particular, cycle characteristics at high temperatures could be effectively improved. Further, it was found that 4-fluoro-1,3-dioxolane-2-one was preferably used as a solvent, since higher effect could be obtained.

Further, as evidenced by comparison of the respective Examples, in Examples 5-1-1, 5-1-2 and Examples 5-25-1, 5-25-2 to 5-27-1, 5-27-2, in which the SnCoC-containing material which contains tin, cobalt, and carbon was used, particularly high characteristics could be obtained. That is, it was found that the SnCoC-containing material was preferably used, since the characteristics could be further improved.

### Examples 6-1 to 6-6

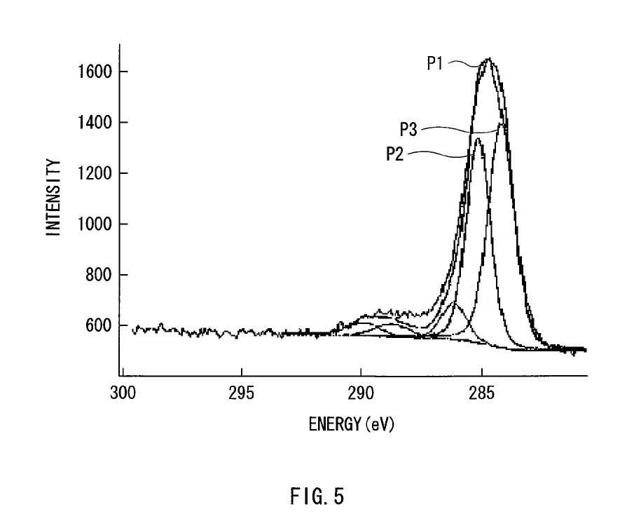

Secondary batteries were fabricated in the same manner as in Example 5-1-1, except that the composition of the SnCoC-containing material was changed. For the formed CoSnC-containing material of Examples 6-1 to 6-6, the composition was analyzed in the same manner as in Example 5-1-1. The results are shown in Tables 11 and 12. Further, for the CoSnC-containing material of Examples 5-1-1 and Examples 6-1 to 6-6, X-ray diffraction was performed. In the result, the diffraction peak having a wide half value width with the diffraction angle 2θ of 1.0 degree or more was observed in the range of diffraction angle 2θ=20 to 50 degrees. Further, when XPS was performed for the CoSnC-containing material, Peak P1 was obtained as shown in FIG. 5. When the Peak P1 was analyzed, Peak P2 of the surface contamination carbon and Peak P3 of C1s in the SnCoC-containing material on the energy side lower than of the Peak P2 were obtained. The Peak P3 was obtained in the region lower than 284.5 eV. That is, it was confirmed that carbon in the SnCoC-containing material was bonded to other element.

Further, for the fabricated secondary batteries of Examples 6-1 to 6-6, the cycle characteristics were measured in the same manner as in Example 5-1-1. The results are shown together with the result of Example 5-1-1 in Tables 11 and 12. In Table 12, the discharge capacity at the first cycle at 25 deg C. was also shown.

TABLE 11

| | Anode active material | | | | | |
|---|---|---|---|---|---|---|
| | Composition | | | Co/Sn + | Discharge capacity | |
| | (wt %) | | | Co | retention ratio (%) | |
| | Sn | Co | C | (wt %) | 25 deg C. | 50 deg C. |
| Example 6-1 | 56.1 | 33.0 | 9.9 | 37 | 79 | 82 |
| Example 5-1-1 | 50.0 | 29.4 | 19.6 | | 91 | 92 |
| Example 6-2 | 43.7 | 25.6 | 29.7 | | 81 | 82 |

TABLE 12

| | Anode active material | | | | Discharge | Discharge capacity | |
|---|---|---|---|---|---|---|---|
| | Composition (wt %) | | | Co/Sn + Co | capacity | retention ratio (%) | |
| | Sn | Co | C | (wt %) | (mAh) | 25 deg C. | 50 deg C. |
| Example 6-3 | 55.4 | 23.8 | 19.8 | 30 | 3410 | 85 | 86 |
| Example 6-4 | 53.1 | 26.1 | 19.8 | 33 | 3350 | 88 | 89 |
| Example 5-1-1 | 50.0 | 29.4 | 19.6 | 37 | 3300 | 91 | 92 |
| Example 6-5 | 31.7 | 47.5 | 19.8 | 60 | 2930 | 92 | 93 |
| Example 6-6 | 23.8 | 55.4 | 19.8 | 70 | 2810 | 93 | 94 |

As shown in Table 11, there was a tendency that as the carbon content was increased, the discharge capacity retention ratio was improved, showed the maximum value, and then decreased. Further, as shown in Table 12, there was a tendency that as the cobalt ratio to the total of tin and cobalt (Co/(Sn+Co)) was increased, the discharge capacity retention ratio was improved, while the discharge capacity was decreased. That is, it was found that the SnCoC-containing material in which the carbon content was in the range from 9.9 wt % to 29.7 wt %, and the cobalt ratio to the total of tin and cobalt (Co/(Sn+Co)) was from 30 wt % to 70 wt % was preferably used, since a high capacity could be obtained and superior cycle characteristics could be obtained.

### Examples 7-1-1, 7-1-2 to 7-5-1, 7-5-2

In Examples 7-1-1 to 7-5-1, secondary batteries were fabricated in the same manner as in Example 2-4, except that the structure of the anode 22 was changed. Then, in Example 7-1-1, the anode 22 was formed by forming the anode active material layer 22B made of silicon on the anode current collector 22A by electron beam vapor deposition and providing heat treatment. In Example 7-2-1, the anode 22 was formed by forming the anode active material layer 22B made of silicon on the anode current collector 22A by sputtering. In Example 7-3-1, the anode 22 was formed by forming the anode active material layer 22B by dispersing 90 wt % of silicon powder with an average particle diameter of 1 μm and 10 wt % of polyvinylidene fluoride as a binder in a disperse medium, coating the anode current collector 22A with the resultant, and firing the resultant. In Example 7-4-1, the anode 22 was formed by forming the anode active material layer 22B made of tin on the anode current collector 22 by plating. In Example 7-5-1, the anode 22 was formed by forming the anode active material layer 22B on the anode current collector 22A by pressure-bonding a lithium metal foil.

In Examples 7-1-2 to 7-5-2, secondary batteries were fabricated in the same manner as in Examples 7-1-1 to 7-5-1, except that a mixed solvent of 20 wt % of 4-fluoro-1,3-dioxolane-2-one, 20 wt % of ethylene carbonate, and 60 wt % of dimethyl carbonate was used for an electrolytic solution. The imide salt used in Examples 7-1-1, 7-1-2 to 7-5-1, 7-5-2 was LiN(CF₃SO₂)(C₃F₇SO₂), and the mixture of 0.5 mol/l of the imide salt and 0.5 mol/l of lithium hexafluorophosphate was used as an electrolyte salt.

As respective Comparative examples relative to the respective Examples, secondary batteries were fabricated in the same manner as in the respective Examples, except that the imide salt was not used as an electrolyte salt, and lithium hexafluorophosphate was dissolved so that the content became 1 mol/l. For the fabricated secondary batteries of the respective Examples and the respective Comparative examples, the cycle characteristics were measured in the same manner as in Example 2-4. The results are shown in Table 13.

TABLE 13

| | | | | | | | | Discharge | |
|---|---|---|---|---|---|---|---|---|---|
| | | | Composition of | | | | | capacity | |
| | Anode | Anode | solvent | | | | | retention | |
| | active | formation | (wt %) | | | Electrolyte salt (mol/l) | | ratio (%) | |
| | material | method | FEC | EC | DMC | LiPF₆ | LiN(CF₃SO₂)(C₃F₇SO₂) | 25 deg C. | 50 deg C. |
| Example 7-1-1 | Si | Electron | — | 40 | 60 | 0.5 | 0.5 | 5 | 8 |
| Example 7-1-2 | | beam | 20 | 20 | 60 | 0.5 | 0.5 | 46 | 47 |
| Comparative | | vapor | — | 40 | 60 | 1.0 | — | 1 | 0 |
| example 7-1-1 | | deposition | | | | | | | |
| Comparative | | | 20 | 20 | 60 | 1.0 | — | 45 | 39 |
| example 7-1-2 | | | | | | | | | |
| Example 7-2-1 | Si | Sputtering | — | 40 | 60 | 0.5 | 0.5 | 6 | 9 |
| Example 7-2-2 | | | 20 | 20 | 60 | 0.5 | 0.5 | 47 | 48 |
| Comparative | | | — | 40 | 60 | 1.0 | — | 2 | 0 |
| example 7-2-1 | | | | | | | | | |
| Comparative | | | 20 | 20 | 60 | 1.0 | — | 45 | 38 |
| example 7-2-2 | | | | | | | | | |
| Example 7-3-1 | Si | Firing | — | 40 | 60 | 0.5 | 0.5 | 5 | 9 |
| Example 7-3-2 | | | 20 | 20 | 60 | 0.5 | 0.5 | 33 | 34 |
| Comparative | | | — | 40 | 60 | 1.0 | — | 0 | 0 |
| example 7-3-1 | | | | | | | | | |
| Comparative | | | 20 | 20 | 60 | 1.0 | — | 30 | 22 |
| example 7-3-2 | | | | | | | | | |
| Example 7-4-1 | Si | Plating | — | 40 | 60 | 0.5 | 0.5 | 6 | 7 |
| Example 7-4-2 | | | 20 | 20 | 60 | 0.5 | 0.5 | 40 | 42 |
| Comparative | | | — | 40 | 60 | 1.0 | — | 1 | 0 |
| example 7-4-1 | | | | | | | | | |
| Comparative | | | 20 | 20 | 60 | 1.0 | — | 38 | 28 |
| example 7-4-2 | | | | | | | | | |
| Example 7-5-1 | Li | pressure | — | 40 | 60 | 0.5 | 0.5 | 33 | 37 |
| Example 7-5-2 | | bonding | 20 | 20 | 60 | 0.5 | 0.5 | 52 | 56 |
| Comparative | | | — | 40 | 60 | 1.0 | — | 30 | 30 |
| example 7-5-1 | | | | | | | | | |
| Comparative | | | 20 | 20 | 60 | 1.0 | — | 50 | 50 |
| example 7-5-2 | | | | | | | | | |

FEC: 4-fluoro-1,3-dioxolane-2-one
EC: ethylene carbonate
DMC: dimethyl carbonate

As shown in Table 13, according to the respective Examples, the discharge capacity retention ration could be improved compared to in the respective Comparative examples not using the imide salt, and in particular, higher effect was shown at 50 deg C. Further, when 4-fluoro-1,3-dioxolane-2-one was used as a solvent, characteristics could be further improved. That is, it was found that when the anode 22 having other structure was used, similar effects could be obtained.

### Examples 8-1-1, 8-1-2 to 8-5-1, 8-5-2

In Examples 8-1-1 to 8-5-1, secondary batteries were fabricated in the same manner as in Example 2-4, except that the structure of the anode 22 was changed, and the open circuit voltage in a full charge state was 4.40 V. Then, in Example 8-1-1, the anode 22 was formed by using the SnCoC-containing material similar to of Example 5-26-1. In Example 8-2-1, the anode 22 was formed by forming the anode active material layer 22B made of silicon by electron beam vapor deposition in the same manner as in Example 7-1-1. In Example 8-3-1, the anode 22 was formed by forming the anode active material layer 22B made of silicon by sputtering in the same manner as in Example 7-2-1. In Example 8-4-1, the anode 22 was formed by forming the anode active material layer 22B by using silicon powder and providing firing in the same manner as in Example 7-3-1. In Example 8-5-1, the anode 22 was formed by forming the anode active material layer 22B by pressure-bonding a lithium metal foil in the same manner as in Example 7-5-1.

In Examples 8-1-2 to 8-5-2, secondary batteries were fabricated in the same manner as in Examples 8-1-1 to 8-5-1, except that a mixed solvent of 20 wt % of 4-fluoro-1,3-dioxolane-2-one, 20 wt % of ethylene carbonate, and 60 wt % of dimethyl carbonate was used for an electrolytic solution. The imide salt used in Examples 8-1-1, 8-1-2 to 8-5-1, 8-5-2 was LiN(CF₃SO₂)(C₃F₇SO₂), and the mixture of 0.5 mol/l of the imide salt and 0.5 mol/l of lithium hexafluorophosphate was used as an electrolyte salt.

As respective Comparative examples relative to the respective Examples, secondary batteries were fabricated in the same manner as in the respective Examples, except that the imide salt was not used as an electrolyte salt, and lithium hexafluorophosphate was dissolved so that the content became 1 mol/l. For the fabricated secondary batteries of the respective Examples and the respective Comparative examples, the cycle characteristics were measured in the same manner as in Example 2-4. The results are shown in Table 14.

TABLE 14
Battery voltage: 4.4 V

| | | | | | | | | Discharge | |
|---|---|---|---|---|---|---|---|---|---|
| | | | Composition of | | | | | capacity | |
| | Anode | Anode | solvent | | | | | retention | |
| | active | formation | (wt %) | | | Electrolyte salt (mol/l) | | ratio (%) | |
| | material | method | FEC | EC | DMC | LiPF₆ | LiN(CF₃SO₂)(C₃F₇SO₂) | 25 deg C. | 50 deg C. |
| Example 8-1-1 | Sn—Co—In—Ti—C | Coating | — | 40 | 60 | 0.5 | 0.5 | 70 | 71 |
| Example 8-1-2 | (49/23.4/5/2/19.6) | | 20 | 20 | 60 | 0.5 | 0.5 | 89 | 90 |
| Comparative | | | — | 40 | 60 | 1.0 | — | 40 | 30 |
| example 8-1-1 | | | | | | | | | |
| Comparative | | | 20 | 20 | 60 | 1.0 | — | 50 | 40 |
| example 8-1-2 | | | | | | | | | |
| Example 8-2-1 | Si | Electron | — | 40 | 60 | 0.5 | 0.5 | 3 | 4 |
| Example 8-2-2 | | beam | 20 | 20 | 60 | 0.5 | 0.5 | 40 | 40 |
| Comparative | | vapor | — | 40 | 60 | 1.0 | — | 0 | 0 |
| example 8-2-1 | | deposition | | | | | | | |
| Comparative | | | 20 | 20 | 60 | 1.0 | — | 25 | 20 |
| example 8-2-2 | | | | | | | | | |
| Example 8-3-1 | Si | Sputtering | — | 40 | 60 | 0.5 | 0.5 | 3 | 4 |
| Example 8-3-2 | | | 20 | 20 | 60 | 0.5 | 0.5 | 41 | 42 |
| Comparative | | | — | 40 | 60 | 1.0 | — | 0 | 0 |
| example 8-3-1 | | | | | | | | | |
| Comparative | | | 20 | 20 | 60 | 1.0 | — | 25 | 19 |
| example 8-3-2 | | | | | | | | | |
| Example 8-4-1 | Si | Firing | — | 40 | 60 | 0.5 | 0.5 | 3 | 4 |
| Example 8-4-2 | | | 20 | 20 | 60 | 0.5 | 0.5 | 27 | 28 |
| Comparative | | | — | 40 | 60 | 1.0 | — | 0 | 0 |
| example 8-4-1 | | | | | | | | | |
| Comparative | | | 20 | 20 | 60 | 1.0 | — | 20 | 10 |
| example 8-4-2 | | | | | | | | | |
| Example 8-5-1 | Li | pressure | — | 40 | 60 | 0.5 | 0.5 | 27 | 27 |
| Example 8-5-2 | | bonding | 20 | 20 | 60 | 0.5 | 0.5 | 46 | 47 |
| Comparative | | | — | 40 | 60 | 1.0 | — | 15 | 15 |
| example 8-5-1 | | | | | | | | | |
| Comparative | | | 20 | 20 | 60 | 1.0 | — | 30 | 28 |
| example 8-5-2 | | | | | | | | | |

FEC: 4-fluoro-1,3-dioxolane-2-one
EC: ethylene carbonate
DMC: dimethyl carbonate

As shown in Table 14, according to the respective Examples, the discharge capacity retention ratio could be improved compared to in the respective Comparative examples not using the imide salt, and in particular, higher effect was shown at 50 deg C. Further, when 4-fluoro-1,3-dioxolane-2-one was used as a solvent, characteristics could be further improved. That is, it was found that when the battery voltage was increased, similar effects could be obtained.

### Examples 9-1-1, 9-1-2 to 9-5-1, 9-5-2, and 9-6-1

The secondary battery shown in FIG. 3 and FIG. 4 was fabricated. First, the cathode 33 was formed in the same manner as in Example 1-1. As an electrical conductor, Ketjen black (manufactured by Lion) was used. Next, the anode 34 was formed. Then, the structure of the anode 34 was changed in each Example. In Examples 9-1-1 and 9-1-2, the anode 34 was formed by using the SnCoC-containing material in the same manner as in Example 5-1-1. As an electrical conductor, graphite (spherocrystal graphite MESOPHASE FINE CARBON•GRAPHITE POWDER manufactured by JFE Steal) was used. In Examples 9-2-1 and 9-2-2, the anode 34 was formed by forming the anode active material layer 34B made of silicon by electron beam vapor deposition in the same manner as in Example 7-1-1. In Examples 9-3-1 and 9-3-2, the anode 34 was formed by forming the anode active material layer 34B made of silicon by sputtering in the same manner as in Example 7-2-1. In Examples 9-4-1 and 9-4-2, the anode 34 was formed by forming the anode active material layer 34B by using silicon powder and providing firing in the same manner as in Example 7-3-1. In Examples 9-5-1 and 9-5-2, the anode 34 was formed by forming the anode active material layer 34B by pressure-bonding a lithium metal foil in the same manner as in Example 7-5-1. In Example 9-6-1, the anode 34 was formed in the same manner as in Example 1-1.

Subsequently, as a high molecular weight compound, a mixture of (A) a copolymer of vinylidene fluoride and hexafluoropropylene with a weight average molecular weight of 0.7 million and (B) a copolymer of vinylidene fluoride and hexafluoropropylene with a weight average molecular weight of 0.31 million at a weight ratio of (A):(B)=9:1 was prepared. The ratio of hexafluoropropylene in the copolymer was 7 wt %. After that, the high molecular weight compound and an electrolytic solution were mixed by using a mixed solvent to prepare a precursor solution. As a solvent of the electrolytic solution, a mixture of 40 wt % of ethylene carbonate and 60 wt % of dimethyl carbonate was used in Examples 9-1-1 to 9-6-1; and a mixture of 20 wt % of 4-fluoro-1,3-dioxolane-2-one, 20 wt % of ethylene carbonate, and 60 wt % of dimethyl carbonate was used in Examples 9-1-2 to 9-5-2. As an electrolyte salt, a mixture of 0.5 mol/l of the imide salt LiN(CF₃SO₂)(C₃F₇SO₂) and 0.5 mol/l of lithium hexafluorophosphate was used.

Next, the cathode 33 and the anode 34 were respectively coated with the prepared precursor solution by using a bar coater. After that, the mixed solvent was volatilized to form the gelatinous electrolyte layer 36. After that, the cathode 33 and the anode 34 were layered with the separator 35 made of polyethylene being 16 μm thick (E16MMS manufactured by Tonen Chemical Corporation) in between, the lamination was flatly wound to form the spirally wound electrode body 30. Subsequently, the spirally wound electrode body 30 was enclosed in the package member 40 made of a laminated film under reduced pressure to obtain the secondary battery.

As respective Comparative examples relative to the respective Examples, secondary batteries were fabricated in the same manner as in the respective Examples, except that the imide salt was not used as an electrolyte salt, and lithium hexafluorophosphate was dissolved so that the content became 1 mol/l.

For the fabricated secondary batteries of the respective Examples and the respective Comparative examples, the cycle characteristics at 25 deg C. and 50 deg C. were measured. The results are shown in Table 15. For the cycle characteristics, 150 cycles of charge and discharge in which after constant current and constant voltage charge of 830 mA was performed at 25 deg C. or 50 deg C. until the upper voltage of 4.2 V, constant current discharge of 660 mA was performed until the final voltage of 2.6 V were performed. Then, the discharge capacity retention ratio (%) at the 150th cycle where the discharge capacity at the first cycle was 100 was obtained.

TABLE 15

| | | | | | | | | Discharge | |
|---|---|---|---|---|---|---|---|---|---|
| | | | Composition of | | | | | capacity | |
| | Anode | Anode | solvent | | | | | retention | |
| | active | formation | (wt %) | | | Electrolyte salt (mol/l) | | ratio (%) | |
| | material | method | FEC | EC | DMC | LiPF₆ | LiN(CF₃SO₂)(C₃F₇SO₂) | 25 deg C. | 50 deg C. |
| Example 9-1-1 | Sn—Co—C | Coating | — | 40 | 60 | 0.5 | 0.5 | 59 | 53 |
| Example 9-1-2 | (49/29.4/ | | 20 | 20 | 60 | 0.5 | 0.5 | 92 | 92 |
| Comparative | 19.6) | | — | 40 | 60 | 1.0 | — | 59 | 50 |
| example 9-1-1 | | | | | | | | | |
| Comparative | | | 20 | 20 | 60 | 1.0 | — | 92 | 85 |
| example 9-1-2 | | | | | | | | | |
| Example 9-2-1 | Si | Electron | — | 40 | 60 | 0.5 | 0.5 | 5 | 5 |
| Example 9-2-2 | | beam | 20 | 20 | 60 | 0.5 | 0.5 | 44 | 45 |
| Comparative | | vapor | — | 40 | 60 | 1.0 | — | 1 | 0 |
| example 9-2-1 | | deposition | | | | | | | |
| Comparative | | | 20 | 20 | 60 | 1.0 | — | 44 | 38 |
| example 9-2-2 | | | | | | | | | |
| Example 9-3-1 | Si | Sputtering | — | 40 | 60 | 0.5 | 0.5 | 5 | 6 |
| Example 9-3-2 | | | 20 | 20 | 60 | 0.5 | 0.5 | 44 | 45 |
| Comparative | | | — | 40 | 60 | 1.0 | — | 1 | 0 |
| example 9-3-1 | | | | | | | | | |
| Comparative | | | 20 | 20 | 60 | 1.0 | — | 45 | 38 |
| example 9-3-2 | | | | | | | | | |
| Example 9-4-1 | Si | Firing | — | 40 | 60 | 0.5 | 0.5 | 5 | 5 |
| Example 9-4-2 | | | 20 | 20 | 60 | 0.5 | 0.5 | 30 | 31 |
| Comparative | | | — | 40 | 60 | 1.0 | — | 0 | 0 |
| example 9-4-1 | | | | | | | | | |
| Comparative | | | 20 | 20 | 60 | 1.0 | — | 30 | 22 |
| example 9-4-2 | | | | | | | | | |
| Example 9-5-1 | Li | pressure | — | 40 | 60 | 0.5 | 0.5 | 25 | 25 |
| Example 9-5-2 | | bonding | 20 | 20 | 60 | 0.5 | 0.5 | 51 | 55 |
| Comparative | | | — | 40 | 60 | 1.0 | — | 14 | 14 |
| example 9-5-1 | | | | | | | | | |
| Comparative | | | 20 | 20 | 60 | 1.0 | — | 47 | 46 |
| example 9-5-2 | | | | | | | | | |
| Example 9-6-1 | Artificial | Coating | — | 40 | 60 | 0.5 | 0.5 | 85 | 93 |
| Comparative | graphite | | — | 40 | 60 | 1.0 | — | 80 | 76 |
| example 9-6-1 | | | | | | | | | |

FEC: 4-fluoro-1,3-dioxolane-2-one
EC: ethylene carbonate
DMC: dimethyl carbonate

As shown in Table 15, in these examples, similarly to in the foregoing other examples, the discharge capacity retention ratio could be improved compared to in the comparative examples, and in particular, higher effect was shown at 50 deg C. Further, when 4-fluoro-1,3-dioxolane-2-one was used as a solvent, characteristics could be further improved. That is, it was found that when the electrolytic solution was held in the high molecular weight compound, similar effects could be obtained.

### Example 10-1

A secondary battery was fabricated in the same manner as in Example 5-1-2, except that the hollow prismatic battery can 11 made of aluminum was used. That is, as an anode active material, a SnCoC-containing material was used. As an electrolytic solution, a solution obtained by dissolving a mixture of 0.5 mol/l of the imide salt LiN(CF₃SO₂)(C₃F₇SO₂) and 0.5 mol/l of lithium hexafluorophosphate in a mixed solvent of 20 wt % of 4-fluoro-1,3-dioxolane-2-one, 20 wt % of ethylene carbonate, and 60 wt % of dimethyl carbonate was used.

As Comparative example 10-1 relative to Example 10-1, a secondary battery was fabricated in the same manner as in Example 10-1, except that the imide salt was not used as an electrolyte salt, and lithium hexafluorophosphate was dissolved so that the content thereof became 1 mol/l. For the fabricated secondary batteries of Example 10-1 and Comparative example 10-1, the cycle characteristics were measured in the same manner as in Example 5-1-2. The results are shown in Table 16.

TABLE 16

| | | | | | | | Discharge | |
|---|---|---|---|---|---|---|---|---|
| | | Composition of | | | | | capacity | |
| | | solvent | | | | | retention | |
| | Anode active | (wt %) | | | Electrolyte salt (mol/l) | | ratio (%) | |
| | material | FEC | EC | DMC | LiPF₆ | LiN(CF₃SO₂)(C₃F₇SO₂) | 25 deg C. | 50 deg C. |
| Example 10-1 | Sn—Co—C | 20 | 20 | 60 | 0.5 | 0.5 | 92 | 92 |
| Comparative | (49/29.4/19.6) | 20 | 20 | 60 | 1.0 | — | 92 | 85 |
| example 10-1 | | | | | | | | |

FEC: 4-fluoro-1,3-dioxolane-2-one
EC: ethylene carbonate
DMC: dimethyl carbonate

As shown in Table 16, in Example 10-1, results similar to of Example 5-1-2 were obtained as well. That is, it was found that similar effects could be obtained even when the shape of the battery can 11 was changed.

The present invention has been described with reference to the embodiments and the examples. However, the present invention is not limited to the foregoing embodiments and the foregoing examples, and various modifications may be made. For example, in the foregoing embodiments and the foregoing examples, descriptions have been given of the case using the electrolytic solution or the gelatinous electrolyte in which an electrolytic solution is held in a high molecular weight compound as an electrolyte. However, other electrolyte may be used. As other electrolyte, for example, a mixture of an ion conductive inorganic compound such as ion conductive ceramics, ion conductive glass, and ionic crystal and an electrolytic solution; a mixture of other inorganic compound and an electrolytic solution; or a mixture of the foregoing inorganic compound and a gelatinous electrolyte can be cited.

Further, in the foregoing embodiments and the foregoing examples, descriptions have been given of the battery using lithium as an electrode reactant. However, the present invention can be applied to the case using other alkali metal such as sodium (Na) and potassium (K), an alkali earth metal such as magnesium and calcium (Ca), or other light metal such as aluminum. Then, for the anode, the anode active material as described in the foregoing embodiments, or a material containing tin or silicon as an element can be similarly used.

Further, in the foregoing embodiments and the foregoing examples, descriptions have been given with specific examples of the cylindrical, square, or laminated film type secondary battery. However, the present invention can be similarly applied to a secondary battery having other shape such as a coin type secondary battery, a button type secondary battery, a card type secondary battery, or a secondary battery having other structure such as a lamination structure. Further, the present invention can be applied to other batteries such as primary batteries in addition to the secondary batteries.

It should be understood by those skilled in the art that various modifications, combinations, sub-combinations and alternations may occur depending on design requirements and other factors insofar as they are within the scope of the appended claims or the equivalents thereof.

What is claimed is:

1. A battery comprising:
a cathode;
an anode; and
an electrolytic solution,
wherein the electrolytic solution contains an imide salt expressed by LiN(CₙF₂ₙ₊₁SO₂)(CₘF₂ₘ₊₁SO₂) (n and m are respectively an integer number from 1 to 4, and a different value from each other).

2. The battery according to claim 1, wherein the imide salt content in the electrolytic solution is from 0.01 mol/l to 1.5 mol/l.

3. The battery according to claim 1, wherein the electrolytic solution further contains lithium hexafluorophosphate.

4. The battery according to claim 1, wherein the anode contains an anode active material containing at least one of silicon (Si) and tin (Sn) as an element.

5. The battery according to claim 4, wherein the anode contains an anode active material containing tin as a first element, a second element, and a third element,
the second element is at least one from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi), and silicon (Si), and
the third element is at least one from the group consisting of boron (B), carbon (C), aluminum (Al), and phosphorus (P).

6. The battery according to claim 4, wherein the anode contains an anode active material containing tin, cobalt, and carbon as an element in which the carbon content is from 9.9 wt % to 29.7 wt %, and the cobalt ratio to the total of tin and cobalt is from 30 wt % to 70 wt %.

7. The battery according to claim 1, wherein the anode contains a carbon material as an anode active material.

8. The battery according to claim 1, wherein the anode uses lithium metal as an anode active material.

9. The battery according to claim 1, wherein the electrolytic solution contains 4-fluoro-1,3-dioxolane-2-one.

10. The battery according to claim 1, wherein an open circuit voltage in a full charge state per a pair of the cathode and the anode is in the range from 4.25 V to 6.00 V.
